(19) United States
(12) Patent Application Publication
(10) Pub. No.: US 2025/0051175 A1
(43) Pub. Date: Feb. 13, 2025

(54) MODULAR PRODUCTION OF AMMONIA

(71) Applicant: Advanced Energy Materials, LLC, Louisville, KY (US)

(72) Inventors: Mahendra Sunkara, Louisville, KY (US); Sivakumar Vasireddy, Louisville, KY (US); Vivekanand Kumar, Louisville, KY (US)

(21) Appl. No.: 18/800,041

(22) Filed: Aug. 10, 2024

Related U.S. Application Data
(60) Provisional application No. 63/532,090, filed on Aug. 11, 2023.

(51) Int. Cl. C01C 1/04; B01J 21/06; B01J 23/04; B01J 23/745; B01J 35/45; B01J 37/02; B01J 37/08; B01J 37/18

(52) U.S. Cl. CPC C01C 1/0494; B01J 21/063; B01J 23/04; B01J 23/745; B01J 35/45; B01J 37/0201; B01J 37/08; B01J 37/18; C01C 1/0429

(57) ABSTRACT

A method of producing ammonia is provided. The method includes steps of oxidizing N₂ gas in a plasma discharge reactor to form NOₓ where x is 1 or 2 and hydrogenating NOₓ in the presence of H₂ on a catalyst to form ammonia. The method may also include steps of providing a plasma discharge reactor with a fixed or fluidized catalyst bed, introducing N₂ gas, an oxidizing agent, and H₂ gas into the plasma discharge reactor to produce ammonia, and collecting the ammonia produced.

### CROSS-REFERENCE TO RELATED APPLICATIONS

This application claims the benefit of U.S. Provisional Patent Application 63/532,090 filed on Aug. 11, 2023, the complete contents of which are herein incorporated by reference.

### FIELD OF THE INVENTION

The present disclosure generally relates to a process for manufacturing ammonia. More particularly, the present disclosure relates to applying a plasma catalysis process for the manufacturing of ammonia at atmospheric pressures.

### BACKGROUND OF THE INVENTION

A variety of processes are followed in the industry for the manufacturing of ammonia. One of the most popular processes includes the Haber-Bosch (H-B) process which is large scale, capital, and energy intensive and consumes about 1 to 2 percent of the world's energy production. One skilled in the art will appreciate that the Haber-Bosch process operates at high pressures. Adapting and miniaturization of these plants to a modular scale may neither be energy efficient nor cost efficient.

Statistically, global ammonia production reached about 175 million metric tons around 2016, most of which was produced from high purity nitrogen (N₂) and hydrogen (H₂) gases mainly by the Haber-Bosch process. Currently, ammonia is typically manufactured using an iron catalyst structurally promoted with aluminum oxide (Al₂O₃) and electronically promoted with potassium at high temperatures of about 400-500 degrees centigrade and pressures of about 150 to 300 bar. The high temperatures and pressures are required because of thermodynamic limitations of the H-B process and as a result, it is efficient at large scale only. Accordingly, these large-scale plants require considerable energy, water resources and a distribution infrastructure to get the products to consumers.

It is known to one skilled in the art that the current state of the art ammonia production is the Haber-Bosch process with a single pass yield from about 8 to about 10 volume percent ammonia in accordance with reaction R1 shown herein below:

N₂(g)+3H₂(g)→2NH₃(g)

ΔH⁰=−91.8KJ/mol(R1);
Temp-400-500 degree Centigrade & P-150-300 bar.

As discussed hereinabove, the H-B process is a relatively high energy consumption process for the manufacture of ammonia. Accordingly, this process has certain challenges including lack of active, selective, scalable, long-lived catalysts for sustainable ammonia synthesis at low temperature and pressure, relatively high pressure and high temperature thermal processes; lack of the optimal/alternative routes for N2 reduction, and a centralized process preventing a combination of new approaches.

Thus, there exists a need in the current systems for methods of manufacturing ammonia which overcome previous disadvantages.

### SUMMARY

The present disclosure provides a plasma catalysis process for the manufacturing of ammonia at atmospheric pressures.

One aspect of the disclosure provides a method for producing ammonia, comprising oxidizing N₂ gas in a plasma discharge reactor to form NOₓ where x is 1 or 2; and hydrogenating NOₓ in the presence of H₂ on a catalyst to form ammonia. In some embodiments, the oxidizing step is performed by contacting N₂ with steam and optionally H₂. In some embodiments, the oxidizing step is performed by contacting N₂ with CO₂. In some embodiments, the oxidizing step is performed by contacting N₂ with air or oxygen. In some embodiments, the oxidizing step is performed in the presence of argon gas. In some embodiments, the hydrogenating step is performed by introducing H₂ at a position above a plasma flame in the plasma discharge reactor. In some embodiments, the plasma discharge reactor is selected from the group consisting of a microwave (MW) plasma torch reactor, a dielectric barrier discharge (DBD) reactor, a radio-frequency (RF) plasma discharge reactor, hot filament reactor, and arc discharge reactor.

In some embodiments, the catalyst is a transition metal catalyst. In some embodiments, the catalyst is a nanowire or nanotube catalyst. In some embodiments, the catalyst is selected from the group consisting of iron alloyed into titania nanowires; iron nanowires; iron-ruthenium alloyed nanoparticles, nanowires, or nanotubes; iron or nickel nanoparticles; iron, nickel, or cobalt nanoparticles with or without alloyed platinum; iron nanotubes; iron nanotubes alloyed with ruthenium or platinum; and lithium aluminate nanowires. In some embodiments, the reactor comprises a fixed catalyst bed. In some embodiments, the reactor comprises a fluidized catalyst bed. In some embodiments, the method is performed at a pressure of less than 5 bars. In some embodiments, a gas flow rate through the reactor is from 5-100 lpm/kWh. In some embodiments, the reactor comprises an ammonia adsorbent either mixed with or positioned downstream of the catalyst. In some embodiments, the method is adiabatic and no external heat is supplied to the catalyst.

Another aspect of the disclosure provides a method for producing ammonia, comprising providing a plasma discharge reactor with a fixed or fluidized catalyst bed; introducing N₂ gas, an oxidizing agent, and H₂ gas into the plasma discharge reactor to produce ammonia; and collecting the ammonia produced.

### BRIEF DESCRIPTION OF THE DRAWINGS

The present invention is illustrated by way of example, and not by way of limitation, in the figures of the accompanying drawings and in which like reference numerals refer to similar elements. Unless otherwise indicated illustrations in the figures are not necessarily drawn to scale.

FIG. 1 is a scheme showing that plasma catalysis significantly enhances efficiency of commercial-scale ammonia production from N₂ and H₂ in accordance with any exemplary embodiment disclosed herein.

FIG. 2 is a diagram showing synergism of plasma excitation of N₂ and H₂ and recombination on catalyst surface to products in accordance with any exemplary embodiment disclosed herein.

FIG. 3A provides reaction mechanisms in accordance with any exemplary embodiment disclosed herein.

FIG. 3B is a schematic illustrating plasma enhanced catalytic ammonia synthesis in accordance with any exemplary embodiment disclosed herein.

FIG. 4A-C is a set of SEM images of alumina nanowires in accordance with any exemplary embodiment disclosed herein.

FIG. 5A-B is a set of SEM images of TiO₂ nanowires in accordance with any exemplary embodiment disclosed herein.

FIG. 6 is a schematic of a lab scale MW plasma catalytic reactor setup for ammonia production in accordance with any exemplary embodiment disclosed herein.

FIG. 7 is a pictorial representation of a reaction set up in accordance with any exemplary embodiment disclosed herein.

FIG. 8 is a pictorial representation of a reaction set up in accordance with any exemplary embodiment disclosed herein.

FIG. 9 is a pictorial representation of an improved two stage condensation in accordance with any exemplary embodiment disclosed herein.

FIG. 10 is a diagram and pictorial representation of a lab scale DBD plasma catalytic reactor in accordance with any exemplary embodiment disclosed herein.

FIG. 11 is an OES spectra of different gas mixtures in accordance with any exemplary embodiment disclosed herein.

FIG. 12A-D is an equilibrium analysis using CHEMKIN EQUIL for various process gas chemistries including (A) CO₂+N₂+H₂, (B) Air+H₂, (C) Air+water, and (D) NO₂+H₂ in accordance with any exemplary embodiment disclosed herein.

FIG. 13 is a schematic of the 3 step Fe-Nanotube synthesis in accordance with any exemplary embodiment disclosed herein.

FIG. 14A-D is a set of TEM images of FeO nanotubes in accordance with any exemplary embodiment disclosed herein.

FIG. 15A-D is an elemental mapping of FeO nanotubes: (A) Structure of Nanotube, (B) Mapping of different elements on the nanotube, (C) Mapping of Iron on the nanotube, and (D) Percentage of different elements in accordance with any exemplary embodiment disclosed herein.

FIG. 16 is a graph showing the effect of No catalyst vs Fe-nanotubes on NH₃ formations in accordance with any exemplary embodiment disclosed herein.

FIG. 17A-B are graphs showing weight loss ((A) weight and (B) deriv. weight) of MgCl₂ using TGA for Run 2 using DBD Plasma Reactor in accordance with any exemplary embodiment disclosed herein.

FIG. 18A-B are graphs showing weight loss ((A) weight and (B) deriv. weight) of MgCl₂ using TGA for MW Plasma Reactor in accordance with any exemplary embodiment disclosed herein.

FIG. 19 is a pictorial representation of a MW plasma reactor setup for fluidization in accordance with any exemplary embodiment disclosed herein.

FIG. 20A-C is a pictorial representation of MW plasma flames in presence of different co-feed gases (A) N₂+CO₂, (B) N₂+Ar, and (C) N₂+Ar+steam from sheath gas inlet in accordance with any exemplary embodiment disclosed herein.

FIG. 21A-C is diagram of MW plasma flames in presence of different co-feed gases (A) N₂, (B) N₂+CO₂/O₂, and (C) NO_{X}+N₂ from sheath gas inlet in accordance with any exemplary embodiment disclosed herein.

FIG. 22A-B is a (A) schematic of DBD reactor and (b) photo of DBD reactor setup in accordance with any exemplary embodiment disclosed herein.

FIG. 23 is a diagram of a Phase IIA lab scale MW Plasma torch integrated with fluidized bed reactor (custom fabricated) with condensation and recycle in accordance with any exemplary embodiment disclosed herein.

FIG. 24 is a schematic of a two-bed system for dielectric barrier discharge based reactor involving catalyst/ammonia absorbent packing in accordance with any exemplary embodiment disclosed herein.

FIG. 25 is a schematic of plasma torch/fluidized bed reactor for ammonia production in accordance with any exemplary embodiment disclosed herein.

FIG. 26 is a schematic of dielectric barrier discharge based reactor in accordance with any exemplary embodiment disclosed herein.

### DETAILED DESCRIPTION

The present invention is best understood by reference to the detailed figures, examples, and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

Embodiments of the invention herein provide a plasma catalysis manufacturing method that may have a transformational impact on gas processing for chemical or fuel production using renewables at relatively lower temperatures and near ambient pressures (below 7 bar and as low as 1 torr). In one embodiment, distributed and modular production of ammonia may be of choice for decentralized production for energy security, and monetization of stranded gas. In one embodiment, the process described herein may employ highly energetic electrons and reactive species, such as, for example, radicals, excited atoms, molecules, and ions, on specially designed catalysts to enhance reaction kinetics and enable otherwise thermodynamically unfavorable reactions to proceed under ambient conditions. In another embodiment, the use of plasma may help in activation and dissociation of the N₂ molecule, which is the rate determining step in ammonia synthesis as known to one of ordinary skill in the art. In one embodiment, the dissociated N atoms may readily react on a catalyst surface with hydrogen, forming ammonia. In another embodiment, the plasma energy may also selectively heat the reactant gas mixture and the catalyst thus making the process energy efficient. The disclosure thus provides a scalable plasma catalysis technology for modular sized mini plants to produce ammonia at the targeted energy consumption.

Embodiments provide a method for producing ammonia, comprising oxidizing N₂ gas in a plasma discharge reactor to form NOₓ where x is 1 or 2; and hydrogenating NOₓ in the presence of H₂ on a catalyst to form ammonia. In some embodiments, the oxidizing step is performed by contacting N₂ with various oxidizing agents (oxidative gases) such as steam, CO₂, air, and oxygen. In some embodiments, the oxidizing step is performed in the presence of argon gas. The hydrogenating step may be performed by introducing H₂ at a position above a plasma flame in the plasma discharge reactor.

Another embodiment provides a method for producing ammonia, comprising providing a plasma discharge reactor with a fixed or fluidized catalyst bed; introducing N₂ gas, an oxidizing agent, and H₂ gas into the plasma discharge reactor to produce ammonia; and collecting the ammonia produced.

In one embodiment, atmospheric pressure plasma discharge reactors employed for manufacturing ammonia includes reactors selected from but not limited to a microwave (MW) plasma torch reactor, a dielectric barrier discharge (DBD) reactor, a radio-frequency (RF) plasma discharge reactor, hot filament reactor, and arc discharge reactor.

A microwave plasma flame is a non-thermal plasma flame. As is known in the art, electromagnetic microwave (MW) energy is produced using a magnetron, the MW energy is transferred to a hollow coaxial electrode using waveguides or structures for guiding electromagnetic waves, then the microwave energy is coupled into a plasma gas to generate the microwave plasma. Optionally, the MW energy may pass through an isolator and/or a precision power dectector and/or a microwave matching unit before entering the waveguide. Suitable systems and reactors are also described in U.S. Pat. Nos. 11,591,226 and 11,103,848 incorporated herein by reference. Experiments involving plasma discharge and its catalysts have demonstrated synergy between plasma excitation and catalyst effect. In some embodiments, a gas flow rate through the reactor is from 5-100 lpm/kWh.

In one embodiment, the catalyst materials may be based on nanowire or nanotube materials. In one embodiment, the catalysts includes, but is not limited to (i) iron nanotubes; (ii) titania, zinc oxide and alumina nanowires alloyed with various elements including but not limited to iron, copper, nickel, and gallium; lithium aluminate/lithium titanate nanowires, ruthenium alloyed iron nanowires/nanotubes; ruthenium alloyed iron alloyed titania nanowires; iron-nickel alloyed nanoparticles, iron oxide nanoparticles, iron alloyed with small amounts of platinum or palladium, nickel-ruthenium alloys supported on titania and alumina nanowires, several metals supported on titania nanowires, among others. In certain exemplary embodiments, (i) iron alloyed into titania nanowires; (ii) iron nanotubes and lithium aluminate nanowires performed with relatively higher activity toward ammonia production in both MW plasma and DBD reactors. In certain embodiments, the catalysts can be coated onto monoliths for allowing higher flow rates. In certain embodiments, the catalysts can be in extrudate or spheronized forms and are used in packed beds or in fluidized beds. In one embodiment, the catalyst is in the form of a powder from 10 micron to 10 mm scale.

In certain embodiments, the process of manufacturing ammonia may also include the use of inert gases selected from among, for example, argon, helium, and a combination thereof. In certain other embodiments, the process of manufacturing ammonia may also include the use of oxygen supplying compounds including but not limited to, carbon dioxide, oxygen and steam. In certain other embodiments, the process of manufacturing ammonia may include both inert and oxygen supplying gases. In an exemplary embodiment, the results showed ammonia concentration in the outlet gas as high as around 10 percent corresponding to 1.2 moles per hour per gram of catalyst in MW PlasCat™ process at 350 W power. In another embodiment, nitrogen with steam and small amounts of hydrogen may yield similar range production rates. In the case of DBD reactor, in an exemplary embodiment, the results suggest a production rate of up to 5 mmol per hour per gram catalyst. In another exemplary embodiment the use of ammonia absorbent along with catalyst may improve the production rate by an order of magnitude. Accordingly, the results with MW plasma torch and catalyst show technical feasibility for ammonia production at atmospheric pressure. The economic and life cycle analysis of ammonia production suggests economical production at 100 Kg/day or higher scale and reduced CO₂ emissions (0.2-0.4 KgCO2 per Kg-NH3) compared to traditional H-B process at 1.8 Kg CO₂ per Kg-NH₃. The modular reactor system can be used at locations of fertilizer manufacturers, energy storage plants and chemicals production plants.

In one embodiment, the process of manufacturing ammonia discussed herein employs a modular skid mounted process that includes advanced thermal process management to effectively produce ammonia at atmospheric pressure. The overall goal of the project is to develop a 10-100 ton/year capacity ammonia production on a skid unit at an energy efficiency of mini-Haber-Bosch (H-B) process.

If the ammonia synthesis could be scaled down, the plants could be distributed in remote locations (for example, close to locations requiring intense use of ammonia, such as agricultural farms) and can take advantage of renewable energy resources. A key requirement for the success of this paradigm shift in strategy is the design of a process that is not restrained by the need for high pressures and high energy efficiency at large scales. Ammonia synthesis processes that can operate at low temperatures and pressure and have ability for small-scale distributed production are of interest for local consumption as energy carrier and chemical production. In one embodiment, the present disclosure provides a modular process and reactor system to produce ammonia at atmospheric pressure utilizing synergistic effect of microwave plasma and catalyst at relatively improved energy efficiency compared to state of the art.

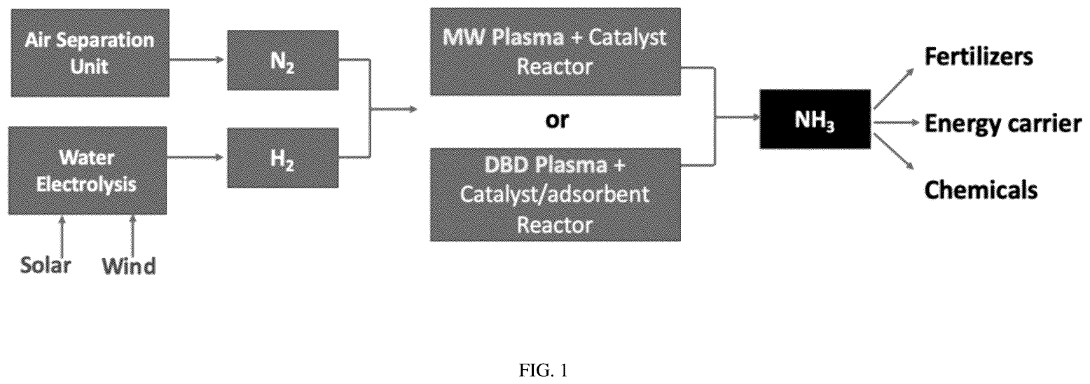

In one embodiment, the process described herein includes a modular reactor system that employs plasma catalysis to significantly enhance efficiency of commercial-scale ammonia production from N₂ and H₂ as shown in FIG. 1. The modular reactor system may be used at locations of fertilizer manufacturers, energy storage plants and chemicals production plants among others.

In one embodiment, advantageously the catalyst used herein results in effective production of ammonia at about atmospheric pressure with an energy efficiency higher than the state of the art. The product yield and selectivity may be relatively improved by employing customized plasma assisted packed bed reactor design described herein. The technology described herein fits rapid start up time frame and may be built into mini-H-B ammonia production plants.

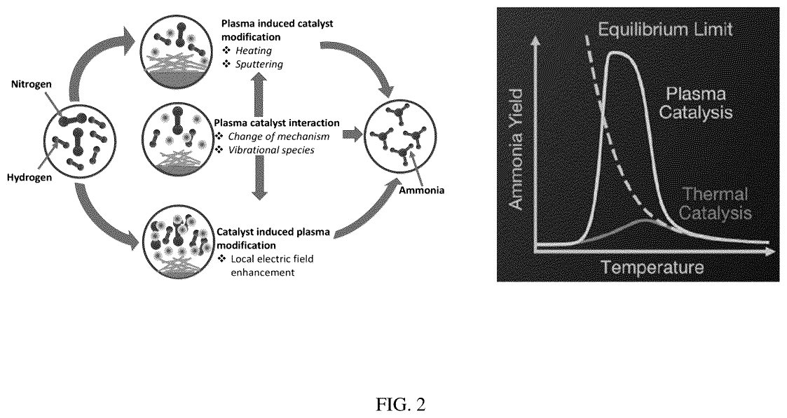

In one embodiment, plasma-assisted catalysis is a process of electrically activating gases in the plasma-phase at low temperatures and ambient pressure to drive reactions on catalyst surfaces. Plasma-assisted catalytic processes combine conventional heterogeneous surface reactions, homogeneous plasma phase reactions, and coupling between plasma-generated species and the catalyst surface. In one embodiment hydrogen may be supplied by a renewable energy source (for example, solar energy or wind energy) or nuclear energy may be used as an energy source for the electrolysis of water and the renewable energy may also be used as energy source for plasma power. MW plasma assisted dry and tri-reforming can be applied to generate syngas where natural gas (NG) pipeline may be available. In one embodiment, plasma activates gas by energetic electrons instead of heat, allowing thermodynamically difficult reactions such as for example N₂ activation to occur with reasonable energy costs. Microwave (MW) plasma activates N₂ and H₂ into reactive species which can then be reacted on catalyst surface to form the products as shown in FIG. 2. In another embodiment, plasma technologies may also be switched on and off relatively easily which may render them compatible with intermittent renewable energy availability and load-following applications. In various embodiments, advantages of the plasma catalysis process described herein include but are not limited to significantly enhancing reaction kinetics and enabling thermodynamically unfavorable reactions to proceed under ambient conditions; providing reactive plasma species, such as electrons, ions, atoms, and radicals with pronounced chemical nonequilibrium leading to highly reactive species and enhancing energy transfer to nanomaterials enabling efficient catalysis even at room temperature and atmospheric pressure; providing higher ammonia (NH₃) yields that may exceed bulk thermodynamic equilibrium limits on materials that are thermal-rate-limited by N₂ dissociation, and providing improved energy efficiency, decreased capital costs, and extended catalyst lifetime.

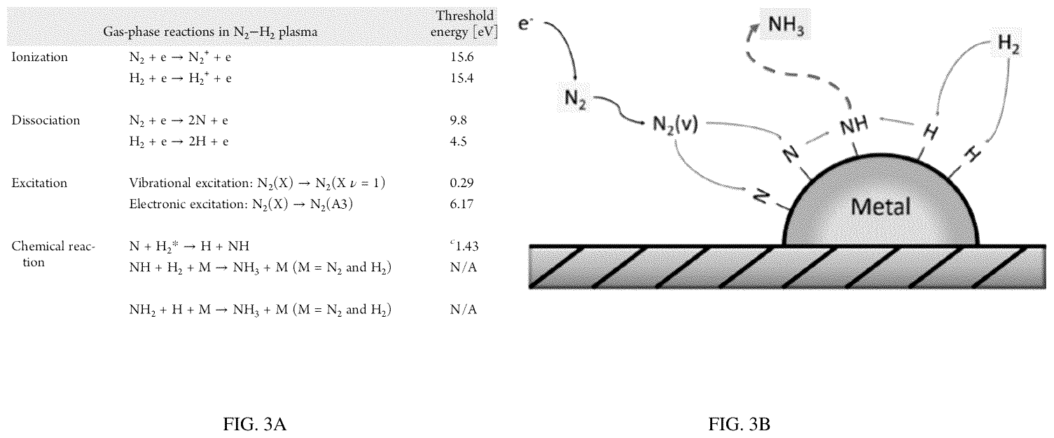

In accordance with embodiments of this invention plasma-enhanced catalytic ammonia synthesis involves dissociative adsorption of excited H₂ and N₂ molecules on a catalyst surface. The nitrogen is vibrationally excited in the plasma, while the catalyst surface performs the final rupture of the bond between the two nitrogen atoms as well as dissociation of H₂. Subsequent hydrogenation of NHx surface species and ammonia desorption occur over the catalyst surface, unaffected by the plasma as shown in FIG. 3A-B.

In various embodiments, the definitions and formulae used for determining the nitrogen conversion, ammonia yield, specific energy input (SEI) and energy efficiency are described herein below.

Definition of terminology used in plasma catalysis specific to ammonia production.

$$The conversion of {N}_{2} is defined as {X}_{N 2} = \frac{moles of N 2 converted}{moles of initial N 2} \times 100$$

$$Yield of ammonia is defined as {Y}_{ammonia} = \frac{moles of ammonia prodcued}{moles of N 2} \times 100$$

Specific energy input (SEI) is defined as plasma power applied divided by the ammonia production rate (mol/hr)

$$SEI ( kWh / mol ) = \frac{power ( kW )}{Ammonia Production rate ( mol {hr}^{- 1} )}$$

SEI is also expressed in electron volts per molecule and is related as follows:

$$SEI ( ev per molecule ) = 0.254 * SEI ( {kJK}^{- 1} )$$

Power throughput is defined as liter per minutes of gases processed in plasma per kW of applied power and is represented as (liters per minute/kW).

$$Power Throughput = \frac{Total Gas flow ( lpm )}{Power Applied ( kW )}$$

Ammonia production (g/kWh) as a function of power (kW) provided in 1 hr is defined as

$$Ammonia Production ( \frac{g}{kWh} ) = \frac{grams of ammonia produced per hour ( g / hr )}{discharge power ( kW )}$$

Ammonia has energy content/density of 0.00625 kWh/g. So the energy efficiency of the system is defined as:

$$Energy Efficiency ( \% ) = ( 0.00625 ( \frac{kWh}{g} ) \times Ammonia Production ( \frac{g}{kWh} ) ) \times 100$$

In one exemplary embodiment, an integrated microwave plasma torch and a packed bed catalyst reactor may be employed for the manufacturing of ammonia. For example, in one embodiment, an integrated MW plasma (0.3-3 kW) and DBD plasma catalytic reactor may be employed for the manufacturing of ammonia.

In one exemplary embodiment, a higher N₂ per pass conversion of about 8 percent conversion with 0.3 kWh/mol of ammonia production at a production rate of about 1.3 moles per hour of ammonia with an energy efficiency of about ˜39% was observed.

In another exemplary embodiment, the presence of a co-feed gas such as CO₂, air or argon improves the ammonia formation. OES analysis of MW plasma of different gas mixtures revealed that the presence of such gases has improved the formation of N₂ active species (N—I and N₂—I) responsible for ammonia production.

In another exemplary embodiment, steam is used as a source of H₂ in the MW plasma reactor to make the economics of ammonia production better. Using steam in presence of N₂ and Ar gave ammonia production at a rate of 340 millimoles per hr.

In another embodiment the designed system for manufacturing ammonia provided a high throughput for nitrogen gas processing (10-30 lpm/kW) thus demonstrating a synergy between catalyst and plasma excitation.

In one embodiment the plasma catalysis process is carried out at atmospheric pressure with no external heat supplied to the catalyst. In one embodiment, the process is adiabatic. In one embodiment, it may be observed that heat generated in plasma process may be sufficient to heat the catalyst.

In one embodiment, the catalyst may be selected from transition metal catalysts containing metals from groups 5, 6, and 8 of the periodic table such as Fe, Pd, Ni, Pt, Rh, Ir, Ag, and Au. In an exemplary embodiment the catalysts may include but are not limited to iron nanotubes, lithium aluminate nanowires, iron alloyed titania nanowires, and nickel alloyed titania nanowires.

In one embodiment, the iron nanotubes catalyst may be manufactured by mixing ZnO nanowires with iron nitrate precursor in water and exposing ultraviolet (UV) irradiation of Fe precursor followed by dissolution of ZnO nanowire template resulting in iron nanotubes.

In another exemplary embodiment, ammonia may be manufactured in a DBD reactor where conversion of N₂, H₂ and CO₂ at atmospheric pressure at a rate of about 5 millimoles per hour per gram of catalyst using 225 Watt power consistently to produce between about 1 to about 5 millimoles per hour per gram of catalyst. In one embodiment the catalyst employed is selected from iron nanotubes, or iron alloyed in titanium dioxide nano wires, or a combination thereof. In yet another embodiment, using an ammonia absorbent along with catalyst may improve ammonia production rate by an order of magnitude. The ammonia adsorbent may be either mixed with or positioned downstream of the catalyst.

With the immobilization of NH₃ on to a solid absorbent (e.g. magnesium chloride), the decrease of the gas phase NH₃ will drive the N₂₊₃H₂→2NH₃ reaction. Also, the use of in-situ absorption of ammonia removes the requirement of conventional Haber-Bosch process condenser which needs to condense ammonia to −20° C. For example, in a fluidized bed reactor, the catalyst mixed with ammonia absorbent may be formed into 0.4-0.6 mm spherical granules and used. The collected powders can be subjected to regeneration to produce concentrated ammonia through heat treatment and then re-used.

In one embodiment, as described hereinabove a MW plasma torch integrated with fluidizing bed catalyst may be manufactured. Controlling contact time between catalyst and plasma excitation, temperature of the catalyst, etc. may provide a scale up in the production of ammonia. Accordingly, in one embodiment, the ammonia production using MW plasma torch/fluidized bed reactor may be optimized by probing for species concentrations, catalyst temperature and process chemistry (steam/hydrogen ratio) and also by understanding the impact of recycled gases.

As described herein above and in the following Examples, in various embodiments, the process described herein demonstrates that plasma catalysis technology to produce ammonia at 6% N₂ conversion at a throughput of 25 lpm/Kw and at pressures <7 bar and at a production rate of 1.5 kg NH₃/day production may be achieved with energy cost of $0.05/kwh. 1 kg NH₃'s energy cost is estimated as $0.7. So, the energy cost of the disclosed ammonia production is estimated as $700/ton, which is about 1.6 times lower than current industry standards. In some embodiments, the plasma reactor comprises a 6 kW/915 MHZ system and demonstrates production at about 10 Kg/day scale. In some embodiments, the process for scaled-up production of ammonia is from 100 Kg/day-1 ton/day.

Before exemplary embodiments of the present invention are described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding cither or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

The invention is further described by the following non-limiting examples which further illustrate the invention, and are not intended, nor should they be interpreted to, limit the scope of the invention.

### EXAMPLES

### Example 1: Synthesis of Porous Al₂O₃ and TiO₂ Nanowire Supports

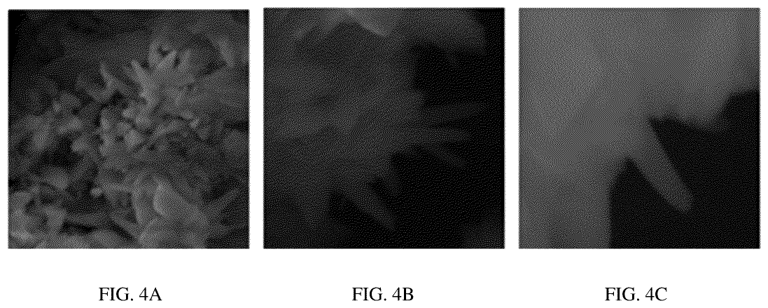

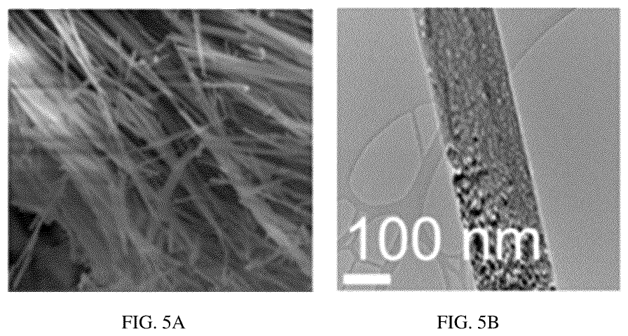

In a first step, nanowires of TiO₂ may be produced in a belt furnace reactor (belt width 12″ inches and length 10′ moving at 2 inch/min) resulting in a residence time of about 1 hour and operating at temperatures 850 degrees Celsius. TiO₂ nanowires may be synthesized by mixing commercially available micron size TiO₂ irregular shape powders and K₂CO₃ powders spread on to a conveyor belt with a film thickness of about 0.5 inch. Metal oxides when mixed with alkali salts and oxidized at 850° C. result in bulk quantities of one-dimensional structures. The resulting one-dimensional nanostructures are treated with hydrochloric acid solution to remove potassium. The process is then followed by drying and calcination steps to convert these nanostructures into TiO₂ nanowires. In one embodiment the nanowire diameter may be controlled by controlling the ratio of TiO₂ and K₂CO₃ powder. Pore size and surface area of TiO₂ nanowires are controlled during HCl treatment to achieve a surface area of about 30 to about 50 square meter per gram of catalyst. In an exemplary embodiment, using similar methods highly porous Al₂O₃ nanowires with surface area about 150-200 m²/g may also be produced as shown in FIG. 4A-C and FIG. 5A-B. FIGS. 4 and 5 show the SEM images of alumina and TiO₂ nanowires respectively.

### Example 2: Production of Catalysts

In step 2, the TiO₂ and Al₂O₃ nanowires produced in step 1 may be used as support materials to make catalysts. The catalysts may be prepared by two different methods: 1. Conventional impregnation and 2. Alloying by vacuum annealing.

Alloyed catalysts by vacuum annealing: Used for alloying one or more than one metal onto metal oxide nanowires, which may be carried out in a vacuum or inert atmosphere furnace. Metal precursors such as acetates or nitrates to be alloyed may be dissolved in deionized (DI) water and mixed with metal oxide nanowires to form a paste. The paste may then be applied to a substrate such as a quartz boat and may be placed inside the vacuum or inert atmosphere chamber. The chamber may be maintained at a temperature of about 450 degrees Celsius for about 3 hours. The chamber is purged with nitrogen before heating to maintain an oxygen lean environment. After vacuum annealing, the product is cooled down and mixed with binder to shape them as cylindrical extrudates. Other catalysts that may be synthesized using this method were FeₓTiO. NWs, Feₓ LTO, NWs (LTO-Lithium titanate) and Feₓ (Al₂O₃), NWs where x (0.1-0.2) and y (0.8-0.9). The metal precursor used for all these catalysts was Iron Nitrate.

Supported catalysts by wet impregnation: Metal precursor to be supported may be dissolved in DI water and mixed with metal oxide nanowires to form a paste. This paste is then transferred to a crucible and placed inside the oven at about 110 degrees Celsius for about 15 hours to dry and then calcined in a box furnace. The calcination is carried out at about 450 degrees Celsius for about 3 hours with a ramp rate of about 5 degrees Celsius per minute. The catalyst from this method is then reduced further in flow of hydrogen gas to 400 degrees Celsius for about 3 hours. For example, the catalysts synthesized using this method were Fe/TiO₂ NWs and Fe/LTO NWS with active metal Fe varies from about 10 to about 20 weight percent. The metal precursor used for all these catalysts in one embodiment is iron nitrate. Catalysts in the form of dried powder made from both the processes were then extruded in a cylinder shape of 2-millimeter diameter and about 10 to 15 millimeter in length using a lab scale extruder.

### Example 3: Ammonia NH₃ Production in a Microwave Plasma Catalysis Reactor Using an Iron-Based Catalyst

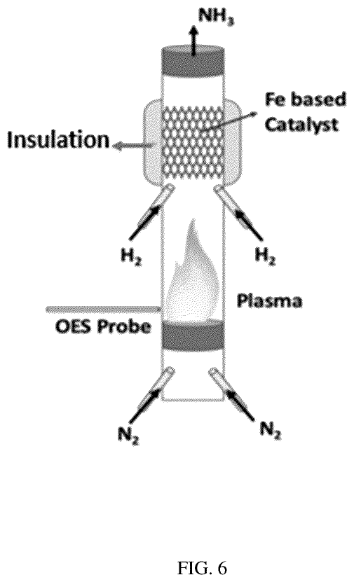

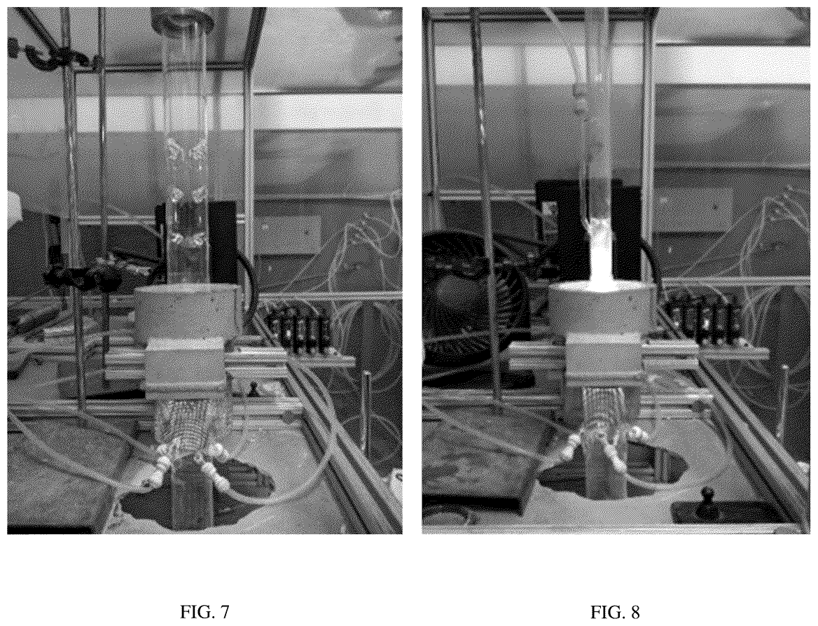

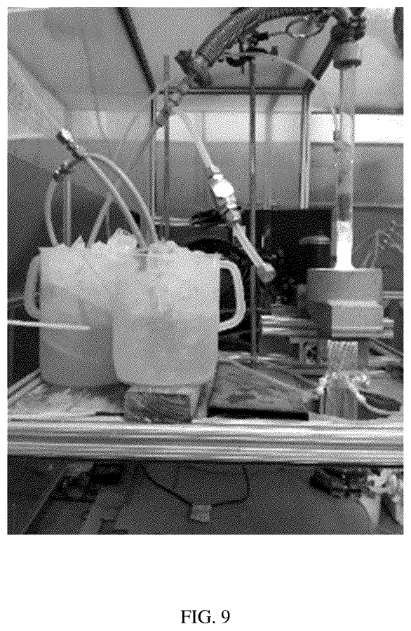

The MW plasma reactor used may have a straight 2-inch diameter reactor with all the gases flowing in the reactor as sheath gas as shown in FIG. 6. As shown in FIG. 6 hydrogen may be passed just below the catalyst bed and all the other gases flow in from the bottom of the reactor as sheath gas as shown in FIG. 8. The reactor is 2-inch in diameter below the applicator and above the applicator. The diameter of the reactor may be reduced to 1 inch. In one embodiment, as shown in FIG. 7, the reactor may be designed as a 1-inch reactor to prevent the plasma flame from quenching in presence of high hydrogen flowrate. In one embodiment, as shown in FIG. 8, polymer tubing was employed as condenser to cool the gas coming off from the outlet of the reactor and passing this cooled gas through one stage scrubber. FIG. 9 shows an exemplary experimental setup with improved reactor design and improvised cooling and gas bubbling system.

The outlet gas from the reactor after being cooled though condenser may be passed through two bottles filled with a known fixed quantity of water. In one embodiment, both the bottles were kept in series and in ice to make sure that all the ammonia formed was getting trapped. The ammonia in the gas phase gets dissolved in water forming ammonium hydroxide. In one embodiment, a gas sample analysis method GC-TCD using a poropak-Q column was developed to detect and arrest ammonia which was going off unaccounted in the exhaust after the scrubber. In one embodiment, this prevented the effect on stability of plasma because of the back pressure on the plasma flame.

Ammonia Product Analysis: To quantify the ammonia formed, the water in which the outlet gas from reactor is absorbed may be scrubbed, is titrated against 0.5 moles and 0.1 moles of sulphuric acid. 20 ml of the water containing the outlet gas is taken into a conical flask and methyl orange was used as an indicator. The color of the liquid after adding the methyl orange changed from colorless to purple. This liquid was titrated against acid until the color changed from purple to colorless/yellow. The pH of the sample was also analyzed using pH meter to make sure that the liquid is basic in nature after ammonia gets dissolved in it.

Calculations for moles of ammonia absorbed in liquid:
x: amount of y M H₂SO₄ titrated
v: volume of water in used to condense ammonia (ml)
t: Run time of the experiment (mins)

$$μmoles of {H}_{2} {SO}_{4} used = ( x * y * 1000 )$$

$$μmoles of Ammonia formed per hour = ( μmoles of {H}_{2} {SO}_{4} used * 2 * v * 60 ) / ( 20 * t )$$

The exhaust gas was also analyzed by GC-TCD to quantify ammonia.

Effect of catalysts and process parameters in a MW plasma reactor: Table 1 and Table 2 provide the reaction product analysis for the experiments done by titrating the liquid in which ammonia rich gas from the reactor outlet was scrubbed. The rate of formation of ammonia formed is under reported because the exhaust gas after the scrubber still had the presence of ammonia in other words the exhaust gas still smelled like ammonia.

Table 1 includes the results of testing the effect of different co-feed gases in presence of 10 percent Fe—TiO₂ supported and reduced catalyst. It is evident from the results in Table 1 that adding co-feed gas in small quantities improved the rate of formation of ammonia from 0.4 milli moles per hour with no co-feed gas to 1 milli moles per hour with Ar as the co-feed gas and 23 milli moles per hour with CO₂ as the co-feed gas.

TABLE 1
Effect of co-feed gas on ammonia production with baseline catalyst

| | | | | | | NH₃ | Energy | |
|---|---|---|---|---|---|---|---|---|
| | N₂ | H₂ | Ar | CO₂ | Power | (mmoles/ | Eff. | Energy |
| Catalyst | (lpm) | (lpm) | (lpm) | (lpm) | (W) | hr)* | (g/kWh) | Eff. |
| 10% | 3 | 3 | 0 | 0 | 350 | 0.4* | 0.02 | 0.01% |
| Fe—TiO₂, | 3 | 3 | 1 | 0 | 350 | 1* | 0.05 | 0.03% |
| Supported, | 3 | 3 | 0 | 0.5 | 350 | 23* | 1.12 | 0.70% |
| Reduced | | | | | | | | |

*The ammonia formation rate is under reported

Table 2 provides the effect of supported and alloyed catalyst in presence of both co-feed gases argon and CO₂. From Table 2, it is observed that both the supported and alloyed catalysts showed similar activity of producing 20 to 23 milli moles per hour in presence of co-reactant CO₂ which is way more as compared to results in presence of co-feed gas Ar. In presence of argon as the co-feed gas 10 percent of Fe—TiO₂ alloyed catalyst showed better performance by producing 10 milli moles per hour as compared to 1 millimoles per hour for 10 percent Fe—TiO₂ supported catalyst.

TABLE 2
Ammonia production over Fe supported vs alloyed with TiO₂ NWs

| | | | | | | NH₃ | Energy | |
|---|---|---|---|---|---|---|---|---|
| | N₂ | H₂ | Ar | CO₂ | Power | (mmoles/ | Eff. | Energy |
| Catalyst | (lpm) | (lpm) | (lpm) | (lpm) | (W) | hr)* | (g/kWh) | Eff. |
| 10% Fe—TiO2, | 3 | 3 | 0 | 0.5 | 350 | 23* | 1.12 | 0.70% |
| Supported, | | | | | | | | |
| Reduced | | | | | | | | |
| 10% Fe—TiO2 | 3 | 3 | 0 | 0.5 | 350 | 20* | 0.97 | 0.61% |
| Alloyed | | | | | | | | |
| 10% Fe—TiO2, | 3 | 3 | 1 | 0 | 350 | 1* | 0.05 | 0.03% |
| Supported, | | | | | | | | |
| Reduced | | | | | | | | |
| 10% Fe—LTO, | 3 | 3 | 1 | 0 | 350 | 5* | 0.24 | 0.15% |
| Supported, | | | | | | | | |
| Reduced | | | | | | | | |
| 10% Fe—TiO2 | 3 | 3 | 1 | 0 | 350 | 10* | 0.49 | 0.30% |
| Alloyed | | | | | | | | |

*The ammonia formation rate is under reported

Since 10 percent Fe—TiO₂ supported showed the maximum ammonia production rate (23 milli moles per hour) in presence of CO₂ as co-feed gas, using the same conditions, effect of reactor surface temperature around the catalyst bed was studied.

Table 3 shows the effect of temperature on ammonia production (milli moles per hour). In one exemplary embodiment, the reactor skin temperature was controlled by adding heat tape around the catalyst bed and insulation. The increase in temperature from 80 degrees Celsius to 380 degrees Celsius has improved the kinetics and ammonia production rate to 52 milli moles per hour.

TABLE 3
Effect of reactor temperature on ammonia production with N₂/H₂ ratio (1/1)

| | | | | | Skin | NH₃ | Energy | |
|---|---|---|---|---|---|---|---|---|
| | N₂ | H₂ | CO₂ | Power | T | (mmoles/ | Eff. | Energy |
| Catalyst | (lpm) | (lpm) | (lpm) | (W) | (° C.) | hr)* | (g/kWh) | Eff. |
| 10% | 3 | 3 | 0.5 | 350 | 80 | 9* | 0.44 | 0.27% |
| Fe—TiO₂, | 3 | 3 | 0.5 | 350 | 220 | 32* | 1.56 | 0.97% |
| Supported, | 3 | 3 | 0.5 | 350 | 300 | 47* | 2.29 | 1.43% |
| Reduced | 3 | 3 | 0.5 | 350 | 380 | 52* | 2.53 | 1.58% |

*The ammonia formation rate is under reported

As known to one skilled in the art, ammonia reforming usually happens at higher temperatures which is from about 400 to about 500 degrees Celsius. It was observed that on increasing the reactor surface temperature to more than 400 degrees Celsius, ammonia may start dissociating back to N₂ and H₂. Tables 4 and 5 show the effect of varying catalysts, MW power and N₂/H₂ ratio in presence of CO₂ on ammonia production. In presence of 10% Ni—TiO₂ (alloyed) and with CO₂ as co-reactant, the reaction shifted towards formation of methane as well. From both Tables 4 and 5, we can say that the iron alloyed catalysts gave a similar ammonia production rate of about 50 to about 60 millimoles per hour and lithium aluminate nanowires gave ammonia production rate of 323 millimoles per hour.

TABLE 4
Effect of catalysts in presence of CO₂ on ammonia production

| | | | | | NH₃ | N₂ | Energy | |
|---|---|---|---|---|---|---|---|---|
| | N₂ | H₂ | CO₂ | Power | (mmoles/ | Conv. | Eff. | Energy |
| Catalyst | (lpm) | (lpm) | (lpm) | (W) | hr) | (%) | (g/kWh) | Eff. |
| No Catalyst | 3 | 2 | 0.3 | 350 | 38 | 0.2% | 1.85 | 1.16% |
| 10% | 3 | 2 | 0.3 | 350 | 57 | 0.4% | 2.77 | 1.73% |
| Fe—TiO₂ | | | | | | | | |
| (Alloyed) | | | | | | | | |
| 10% | 3 | 2 | 0.3 | 350 | 175 | 1.1% | 8.52 | 5.32% |
| Ni—TiO₂ | | | | | | | | |
| (Alloyed) | | | | | | | | |
| Lithium | 3 | 2 | 0.3 | 350 | 323 | 2.0% | 15.72 | 9.82% |
| Aluminate | | | | | | | | |

TABLE 5
Effect of MW power and N₂/H₂ ratio in presence of CO₂ on ammonia production

| | | | | | | NH₃ | N₂ | Energy | |
|---|---|---|---|---|---|---|---|---|---|
| | N₂ | H₂ | CO₂ | N₂/ | Power | (mmoles/ | Conv. | Eff. | Energy |
| Catalyst | (lpm) | (lpm) | (lpm) | H₂ | (W) | hr) | (%) | (g/kWh) | Eff. |
| 20% | 3.0 | 1.1 | 0.3 | 2.7 | 300 | 34 | 0.21% | 1.93 | 1.21% |
| Fe—Al₂O₃ | 4.7 | 1.1 | 0.3 | 4.3 | 300 | 56 | 0.22% | 3.18 | 1.99% |
| (Alloyed) | 4.7 | 1.1 | 0.3 | 4.3 | 350 | 60 | 0.24% | 2.92 | 1.82% |

Table 6 below shows the effect of Ar in the reaction chemistry set. For all the experiments with Ar as a co reactant with nitrogen and hydrogen, we found that ammonia production is enhanced without using Ar. Ni alloyed TiO₂ NWs and Lithium aluminate NWs performed at high activity. However, in addition to ammonia, the formation of NOₓ species were also observed with addition of Ar to gas phase.

TABLE 6
Effect of catalysts in presence of Ar on ammonia production

| | | | | | NH₃ | N₂ | Energy | |
|---|---|---|---|---|---|---|---|---|
| | N₂ | H₂ | Ar | Power | (mmoles/ | Conv. | Eff. | Energy |
| Catalyst | (lpm) | (lpm) | (lpm) | (W) | hr) | (%) | (g/kWh) | Eff. |
| No | 3 | 2 | 1 | 350 | 44 | 0.27% | 2.14 | 1.34% |
| Catalyst | | | | | | | | |
| 10% | 3 | 2 | 1 | 350 | 57 | 0.35% | 2.77 | 1.73% |
| Fe—TiO₂ | | | | | | | | |
| (Alloyed) | | | | | | | | |
| 10% | 3 | 2 | 1 | 350 | 248 | 1.54% | 12.07 | 7.54% |
| Ni—TiO₂ | | | | | | | | |
| (Alloyed) | | | | | | | | |
| Lithium | 3 | 2 | 1 | 350 | 418 | 2.60% | 20.34 | 12.71% |
| Aluminate | | | | | | | | |

In one embodiment, the cofeeding of CO₂/Air may have improved the ammonia production due to the formation of NOₓ by activating N₂ with O from air or CO₂ in presence of MW plasma. The NOₓ then reacted with H species forming ammonia and water.

### Example 4: Ammonia Production in a DBD Plasma Catalysis Reactor

As discussed herein above, dielectric barrier discharge (DBD) plasma is a type of low temperature plasma (LTP) that generates highly energetic electrons and reactive species (e.g., radicals, excited atoms, molecules, and ions) that can significantly enhance reaction kinetics and enable thermodynamically unfavorable reactions to proceed under ambient conditions (e.g., dissociation of N₂). Both the electrons and reactive species play a vital role in the initiation and propagation of a variety of physical and chemical reactions in low-temperature plasma processes. In this task, a modified DBD plasma catalysis packed bed reactor will be used.

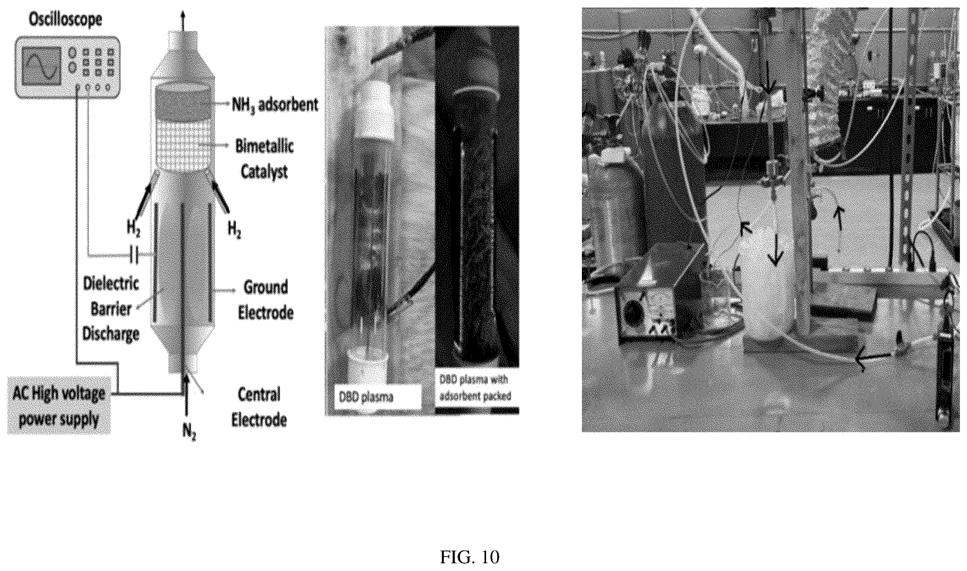

As shown in FIG. 10, the reactor comprises a quartz tube with DBD plasma zone and packed catalyst/adsorbent zone. The DBD is generated in the reactor using a high voltage AC power source (PMV500) with a frequency in the range of 20-25 kHz (kilo hertz). The voltage and charge may be measured using an oscilloscope. For the NH₃ synthesis, the N₂ gas enters the DBD plasma zone and gets activated. The H₂ gas is introduced into the reactor at the entrance of the catalyst zone. The N₂—H₂ plasma immediately interacts with bimetallic catalyst and forms NH₃ at ambient pressure.

Tables 7 to 10 show the DBD plasma catalytic tests results with different catalysts, varying the N₂/H₂ ratio, power, and effect of co-feeding CO₂ using DBD reactor as shown in FIG. 10. In an exemplary embodiment, the 10 percent Fe—TiO₂ alloyed catalyst has shown ammonia formation at 2 milli moles per hour.

Table 7 shows the effect of varying the N₂/H₂ ratio from (1/1) to (2/1). The results show that 10% Fe—TiO₂ alloyed catalyst is showing the best ammonia formation at both the ratio which is 1.6 mmol/h for N₂/H₂ ratio (1/1) and 2 mmol/hr for N₂/H₂ ratio from (2/1).

TABLE 7
Effect of catalyst with N₂/H₂ ratio (1/1) on
ammonia production in DBD plasma catalyst

| | | | | NH₃ | N₂ | Energy | |
|---|---|---|---|---|---|---|---|
| | N₂ | H₂ | Power | (mmoles/ | Conv. | Eff. | Energy |
| Catalyst | (lpm) | (lpm) | (W) | hr) | (%) | (g/kWh) | Eff. |
| 20% Fe—Al₂O₃ | 0.03 | 0.015 | 225 | 0.44 | 0.27% | 0.03 | 0.02% |
| (Alloyed) | | | | | | | |
| 10% Fe—TiO₂ | 0.03 | 0.015 | 225 | 2.01 | 1.25% | 0.15 | 0.10% |
| (Alloyed) | | | | | | | |
| 10% Fe—TiO₂ | 0.03 | 0.015 | 225 | 0.96 | 0.60% | 0.07 | 0.05% |
| (Supported, | | | | | | | |
| Reduced) | | | | | | | |
| 10% Fe—LTO | 0.03 | 0.015 | 225 | 1.69 | 1.05% | 0.13 | 0.08% |
| (Supported, | | | | | | | |
| Reduced) | | | | | | | |
| 10% Fe—LTO | 0.03 | 0.015 | 225 | 0.075 | 0.05% | 0.03 | 0.02% |
| (Alloyed) | | | | | | | |

TABLE 8
Effect of catalyst with N₂/H₂ ratio (2/1) on
ammonia production in DBD plasma catalysts

| | | | | NH₃ | N₂ | Energy | |
|---|---|---|---|---|---|---|---|
| | N₂ | H₂ | Power | (mmoles/ | Conv. | Eff. | Energy |
| Catalyst | (lpm) | (lpm) | (W) | hr)* | (%) | (g/kWh) | Eff. |
| No | 0.05 | 0.05 | 120 | 0.74 | 0.04% | 0.10 | 0.07% |
| Catalyst | 0.05 | 0.05 | 180 | 0.69 | 0.03% | 0.07 | 0.04% |
| | 0.05 | 0.05 | 240 | 0.59 | 0.03% | 0.04 | 0.03% |
| | 0.05 | 0.05 | 300 | 0.55 | 0.03% | 0.03 | 0.02% |

Tables 9-10 show the effect of CO₂ as co-reactant with varying the N₂/H₂ ratio from (1/1) to (2/1). From both tables, we see that 10 percent Fe—TiO₂ alloyed catalyst is showing a consistent ammonia formation at both the ratio which is 0.24 millimoles per hour for N₂/H₂ ratio (1/1) and 0.21 millimoles per hour for N₂/H₂ ratio from (2/1). In an exemplary embodiment, overall rate of ammonia formation for all the catalyst may be similar and more with CO₂ as co-reactant with N₂/H₂ ratio (1/1) that is 0.2-0.36 mmol/hr as compared to N₂/H₂ ratio (2/1).

TABLE 9
Effect of CO₂ co-feed with N₂/H₂ ratio (1/1) on
ammonia production in DBD plasma catalysts.

| | | | | | NH₃ | N₂ | Energy | |
|---|---|---|---|---|---|---|---|---|
| | N₂ | H₂ | CO₂ | Power | (mmoles/ | Conv. | Eff. | Energy |
| Catalyst | (lpm) | (lpm) | (lpm) | (W) | hr) | (%) | (g/kWh) | Eff. |
| 20% Fe—Al₂O₃ | 0.020 | 0.020 | 0.010 | 210 | 0.34 | 0.31% | 0.03 | 0.02% |
| (Alloyed) | | | | | | | | |
| 10% Fe—TiO₂ | 0.020 | 0.020 | 0.010 | 240 | 0.24 | 0.22% | 0.02 | 0.01% |
| (Alloyed) | | | | | | | | |
| 10% Fe—TiO₂ | 0.020 | 0.020 | 0.010 | 225 | 0.36 | 0.34% | 0.03 | 0.02% |
| (Supported, | | | | | | | | |
| Reduced) | | | | | | | | |
| 10% Fe—LTO | 0.020 | 0.020 | 0.010 | 240 | 0.21 | 0.20% | 0.01 | 0.01% |
| (Supported, | | | | | | | | |
| Reduced) | | | | | | | | |

TABLE 10
Effect of CO₂ co-feed with N₂/H₂ ratio (2/1) on
ammonia production in DBD plasma catalysts.

| | | | | | NH₃ | N₂ | Energy | |
|---|---|---|---|---|---|---|---|---|
| | N₂ | H₂ | CO₂ | Power | (mmoles/ | Conv. | Eff. | Energy |
| Catalyst | (lpm) | (lpm) | (lpm) | (W) | hr) | (%) | (g/kWh) | Eff. |
| 20% Fe—Al₂O₃ | 0.040 | 0.020 | 0.010 | 180 | 0.12 | 0.05% | 0.011 | 0.007% |
| (Alloyed) | | | | | | | | |
| 10% Fe—TiO₂ | 0.040 | 0.020 | 0.010 | 240 | 0.21 | 0.10% | 0.015 | 0.009% |
| (Alloyed) | | | | | | | | |
| 10% Fe—TiO₂ | 0.040 | 0.020 | 0.010 | 210 | 0.15 | 0.07% | 0.012 | 0.008% |
| (Supported, | | | | | | | | |
| Reduced) | | | | | | | | |

In various embodiments as previously discussed herein, the temperature of the reactor from inside that is the catalyst bed temperature may play a role in rate of formation of ammonia. In order to control the temperature and to avoid over heating of the catalyst bed, we studied the effect of interrupted pulse DBD with running the DBD continuously. Tables 11 and 12 show the results for different catalysts with N₂/H₂ ratio (1/1) and N₂/H₂ ratio (2/1) respectively. For Pulsing, DBD was switched on for 3 mins and switched off for 1 min.

TABLE 11
Pulse DBD vs continuous run for N₂/H₂ ratio (1/1)

| | | | | | NH₃ | N₂ | Energy | |
|---|---|---|---|---|---|---|---|---|
| | | N₂ | H₂ | Power | (mmoles/ | Conv. | Eff. | Energy |
| Catalyst | Run Type | (lpm) | (lpm) | (W) | hr) | (%) | (g/kWh) | Eff. |
| 10% Fe—TiO₂ | Continuous | 0.025 | 0.025 | 225 | 1.63 | 1.22% | 0.123 | 0.077% |
| (Alloyed) | Pulse | 0.025 | 0.025 | 240 | 2.18 | 1.63% | 0.155 | 0.097% |
| 10% Fe—LTO | Continuous | 0.025 | 0.025 | 225 | 1.53 | 1.14% | 0.116 | 0.072% |
| (Supported, | Pulse | 0.025 | 0.025 | 240 | 1.67 | 1.25% | 0.119 | 0.074% |
| Reduced) | | | | | | | | |
| 10% Fe—LTO | Continuous | 0.025 | 0.025 | 225 | 0.028 | 0.02% | 0.002 | 0.001% |
| (Alloyed) | Pulse | 0.025 | 0.025 | 240 | 0.25 | 0.19% | 0.018 | 0.011% |

TABLE 12
Pulse DBD vs continuous run for N₂/H₂ ratio (2/1)

| | | | | | NH₃ | N₂ | Energy | |
|---|---|---|---|---|---|---|---|---|
| | | N₂ | H₂ | Power | (mmoles/ | Conv. | Eff. | Energy |
| Catalyst | Run Type | (lpm) | (lpm) | (W) | hr) | (%) | (g/kWh) | Eff. |
| 10% Fe—TiO₂ | Continuous | 0.030 | 0.015 | 225 | 2.01 | 1.25% | 0.152 | 0.095% |
| (Alloyed) | Pulse | 0.030 | 0.015 | 240 | 2.02 | 1.26% | 0.153 | 0.096% |
| 10% Fe—LTO | Continuous | 0.030 | 0.015 | 225 | 1.69 | 1.05% | 0.128 | 0.080% |
| (Supported, | Pulse | 0.030 | 0.015 | 240 | 1.6 | 1.00% | 0.121 | 0.076% |
| Reduced) | | | | | | | | |
| 10% Fe—LTO | Continuous | 0.030 | 0.015 | 225 | 0.075 | 0.05% | 0.006 | 0.004% |
| (Alloyed) | Pulse | 0.030 | 0.015 | 240 | 0.266 | 0.17% | 0.020 | 0.013% |

### Example 5. Improving Energy and Conversion Efficiency of Plasma-Catalysis Process in the Manufacturing of Ammonia

Plasma diagnostics was performed and optical emission spectroscopy (OES) was recorded while running all the experiments. The OES probe was placed in such a way that it pointed right at the plasma flame region to get a clear understanding of how the gases were getting dissociated into different species. To get an understanding of N₂ plasma, presence of different co-feed gas, and its dissociation into different ions and molecules, optical emission spectrum of gas mixtures was studied.

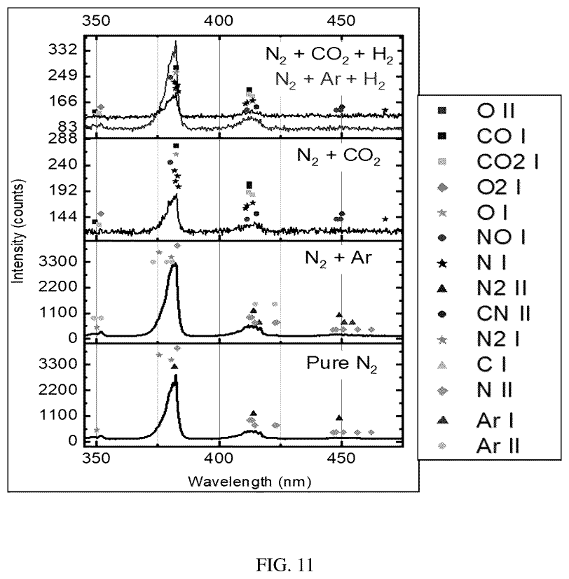

FIG. 11 shows OES spectra of different gas mixtures and the excited species present in that system. Gas (X) labelled as X I means that it is at its first ionized state i.e., after removing one electron (X⁺). Gas labelled as X II means that it is at its second ionized state i.e., after removing two electrons (X²⁺). The results showed that no species containing H were observed, N₂+CO₂ seem to have a higher (N₂-I+N-I)/(N₂-II+N-II) ratio than mixtures with no CO₂, addition of Ar seems to result in more N-I concentration, and it may be possible that N-I and N₂-I species are more reactive than N-II and N₂-II species and their concentration can be increased when CO₂ is present. It was also observed that another possible cause of higher NH₃ production in the presence of CO₂ is that it allows formation of intermediate species such as CN—I and NO—I.

### Example 6: Thermodynamic Equilibrium Analysis of Different Process Chemistries

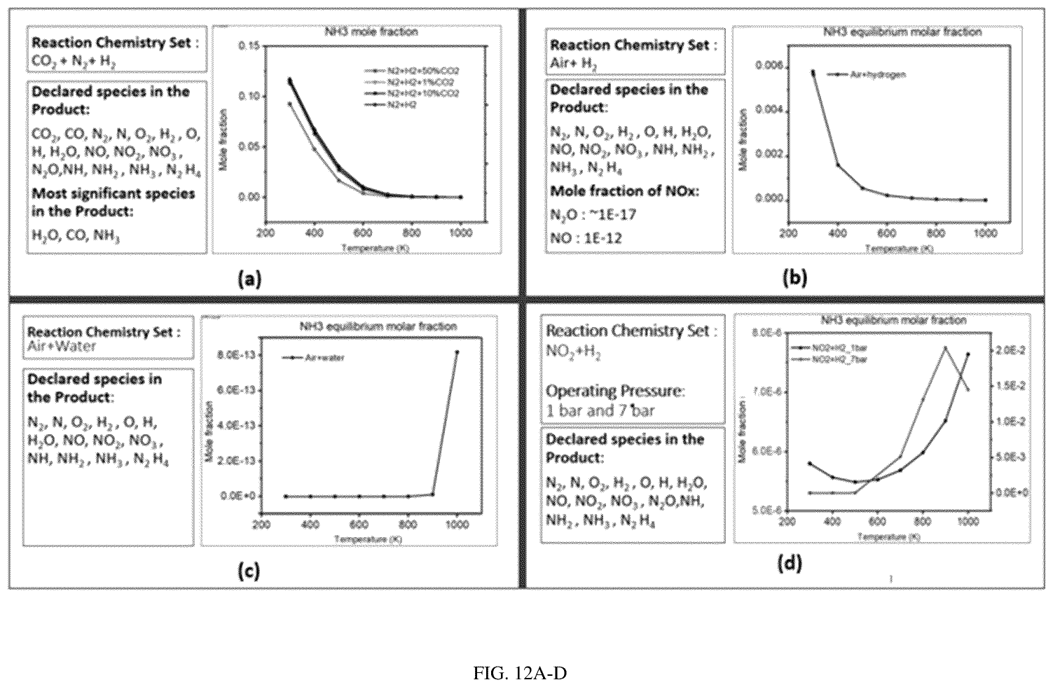

Thermodynamic analysis is conducted for several gas phase chemistries involving nitrogen, hydrogen, oxygen, CO₂, steam and NO₂ species. FIG. 12A-D shows predicted equilibrium compositions for ammonia using four different gas phase chemistries: (a) N₂, H₂ and CO₂; (b) Air and Hydrogen; (c) Air and Water; (d) NO₂ and H₂. The results show that the equilibrium composition of ammonia is predicted to be as high as 10% at low temperatures (<50 C). The addition of CO₂ did not affect the results. The use of air instead of nitrogen predicts similar behavior but much lower values for ammonia than those involving pure nitrogen. Process chemistry involving nitrogen and steam predicts negligible equilibrium composition. The use of NO₂ and hydrogen predicts increasing ammonia composition with temperature.

TABLE 13
delGf (kJ/mol) of different species used.

| | del Gf (KJ/mol) | | |
|---|---|---|---|
| Species | 300K | 400K | 600K |
| N₂ | 0.00 | 0.00 | 0.00 |
| O₂ | 0.00 | 0.00 | 0.00 |
| NO₂ | 51.37 | 57.56 | 70.19 |
| H₂ | 0.00 | 0.00 | 0.00 |
| NH₃ | −16.23 | −5.98 | 15.83 |
| H₂O | −228.54 | −223.96 | 15.83 |
| NO | 86.58 | 85.33 | 82.82 |

Gibbs free energy analysis for several reactions involving nitrogen, steam, oxygen and hydrogen are shown in Table 14. Nitrogen reaction with steam to produce NOₓ and hydrogen can become spontaneous at higher temperatures (with delta G for reaction decreasing with increasing temperature). Hydrogen of NO₂ with hydrogen seems to be spontaneous at low temperatures.

TABLE 14
delGf (KJ/mol) of different reactions

| | del G(rxn) (kJ/mol) | | |
|---|---|---|---|
| Reaction | 300K | 400K | 600K |
| N₂ + 2O₂ = 2NO₂ | 102.7 | 115.1 | 140.4 |
| 2NO₂ + 7H₂ = 2NH₃ + 4H₂O | −1049.4 | −1022.9 | −45.4 |
| N₂ + 4H₂O = 2NO₂ + 4H₂ | 1016.9 | 1011.0 | 77.0 |
| N₂ + O₂ = 2NO | 173.2 | 170.7 | 165.6 |

### Example 7. Optimization of Fe Based Bimetallic Catalysts and Fe Nanotubes

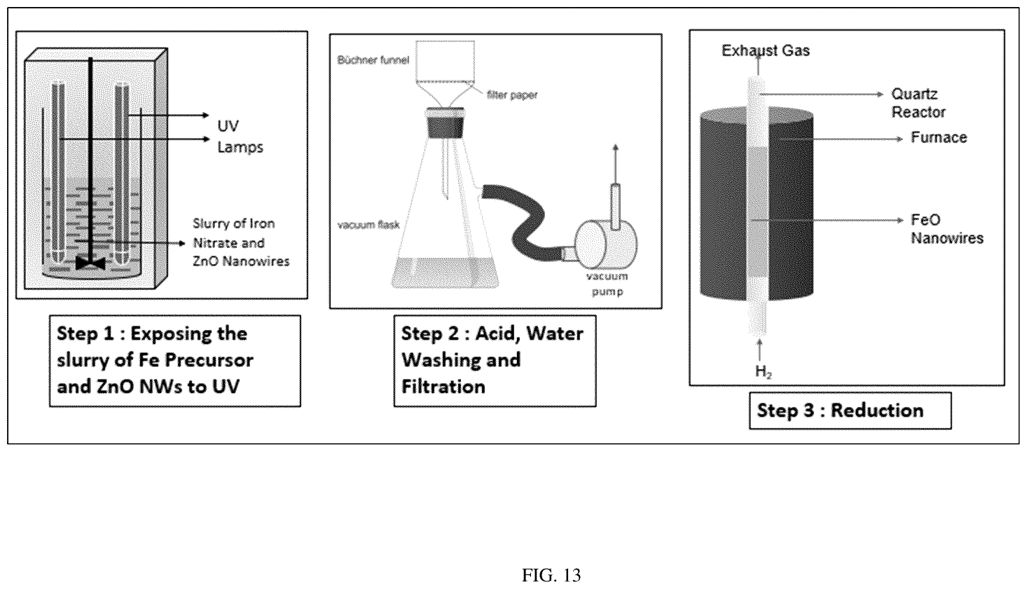

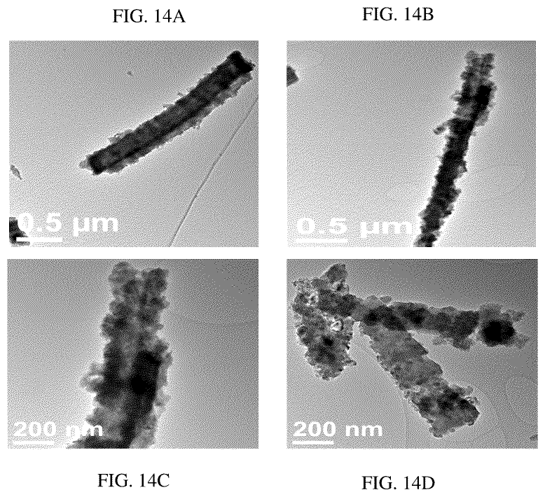

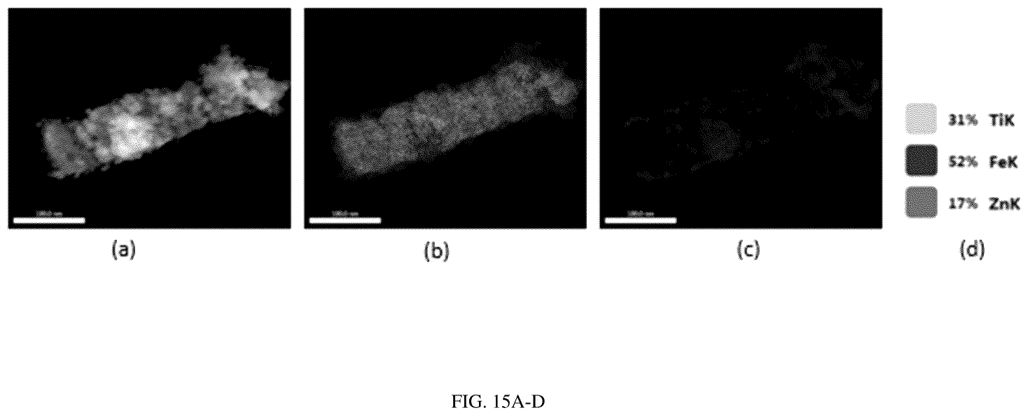

FeO nanotubes may be produced using ZnO nanowires as template. FIG. 13 shows the schematics of production on lab scale. The aqueous Fe precursor solution was mixed with ZnO nanowires at 20 weight percent and irradiated under UV light for 2-3 hours. The slurry was then filtered and stirred in 2N H₂SO₄ for 20-30 min to dissolve ZnO, leaving FeO nanotubes. The FeO powder was then filtered and washed with DI H₂O. The resultant FeO nanotubes were characterized by TEM (FIG. 14A-D) and Elemental Mapping (FIG. 15A-D).

Bi-metallic FeO/Ru/Ni/Ga nanotubes: The bimetallic catalysts were prepared by mixing FeO nanotubes with metallic precursor (Ni, Ga, Ru) solution and then dried in oven. The dried powder was then calcined in a vacuum furnace at 450° C. for 3 h.

### Example 8: Ammonia Production in MW Plasma Reactor Over Fe Nanotubes and Bimetallic Catalysts

Tables 15-16 show the ammonia production activity over Fe nanotubes and bimetallic in MW plasma reactor studied the effect of CO₂ (Table 15) and Air (Table 16) as co-feed gases and compared the results with blank test. The Fe nanotubes catalyst showed much better N₂ conversion (6.8-8%) and rate of ammonia formation at 1-1.3 mol/h compared to bimetallic catalysts.

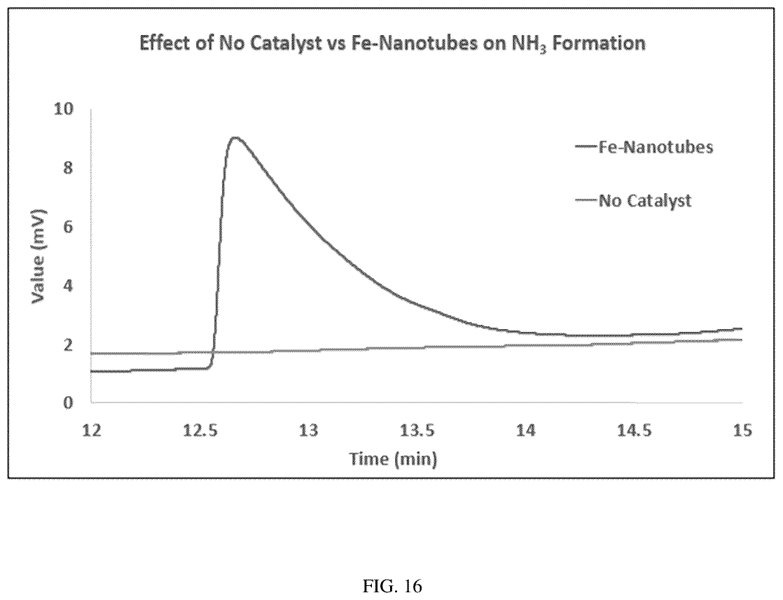

From FIG. 16, we can see the GC-TCD results of ammonia formation in presence of our best performing catalyst that is Fe-Nanotubes giving 1.3 milli moles per hour rate of formation of ammonia compared to no catalyst giving us 0.038 milli moles per hour rate of ammonia formation.

TABLE 15
Ammonia production over Fe nanotubes and
bimetallic catalysts in MW plasma and CO₂

| | | | | | NH₃ | N₂ | Energy | |
|---|---|---|---|---|---|---|---|---|
| | N₂ | H₂ | CO₂ | Power | (mmoles/ | Conv. | Eff. | Energy |
| Catalyst | (lpm) | (lpm) | (lpm) | (W) | hr) | (%) | (g/kWh) | Eff. |
| No Catalyst | 3 | 2 | 0.3 | 350 | 38 | 0.24% | 1.8 | 1.16% |
| Fe-Nanotubes | 3 | 2 | 0.3 | 350 | 1277 | 7.95% | 62.1 | 38.83% |
| (UV: 2 hrs) | | | | | | | | |
| Fe-Nanotubes | 3 | 2 | 0.3 | 330 | 1092 | 6.79% | 51.6 | 32.25% |
| (UV: 3 hrs) | | | | | | | | |
| Fe—Ru | 3 | 2 | 0.3 | 350 | 52 | 0.32% | 2.5 | 1.58% |
| Nanotubes | | | | | | | | |
| Ga—Fe | 3 | 2 | 0.3 | 350 | 15 | 0.09% | 0.7 | 0.46% |
| Nanotubes | | | | | | | | |
| Ni—Fe | 3 | 1 | 0.45 | 300 | 18 | 0.11% | 1.0 | 0.64% |
| Nanotubes | | | | | | | | |

TABLE 16
Ammonia production over Fe nanotubes and
bimetallic catalysts in MW plasma and air

| | | | | | NH₃ | N₂ | Energy | |
|---|---|---|---|---|---|---|---|---|
| | N₂ | H₂ | Air | Power | (mmoles/ | Conv. | Eff. | Energy |
| Catalyst | (lpm) | (lpm) | (lpm) | (W) | hr) | (%) | (g/kWh) | Eff. |
| Fe-Nanotubes | 3.0 | 1.2 | 0.3 | 320 | 36 | 0.21% | 1.9 | 1.20% |
| (UV: 2 hrs) | | | | | | | | |
| Ga—Fe | 3.2 | 1.2 | 0.5 | 350 | 32 | 0.17% | 1.6 | 0.97% |
| Nanotubes | | | | | | | | |

Table 17 shows the effect of passing steam with nitrogen and argon as sheath gas and some hydrogen from just above the catalyst bed. In one embodiment, the reactor was operated for about 10 to 15 minutes with just nitrogen (4 liters per minute) and argon (1 liter per minute) bubbling through water as the sheath gas. In these 15 mins, a lot of colorless gas was observed which may be NO or N₂O. After 15 mins, we started passing hydrogen to the system from right below the catalyst bed and the NOₓ immediately reacted with H₂ to form NH₃. The white colorless gas completely vanished off and ammonia production was observed at 340 milli moles per hour.

TABLE 17
Ammonia production in presence of steam with Fe-Nanotubes

| | | | | | NH₃ | N₂ | Energy | |
|---|---|---|---|---|---|---|---|---|
| | N₂ | H₂ | Ar | Power | (mmoles/ | Conv. | Eff. | Energy |
| Catalyst | (lpm) | (lpm) | (lpm) | (W) | hr) | (%) | (g/kWh) | Eff. |
| Fe-Nanotubes | 3 | 0.6 | 13 | 350 | 340 | 1.51% | 16.5 | 10.34% |
| (UV: 3 hrs) | | | | | | | | |

In one exemplary embodiment, the plasma catalysis technology described herein has produced 56.5 grams per kilo watt hour of ammonia. Most importantly, such energy efficiency is obtained at high production rates of 1.3 moles per hour which is at least three orders of magnitude.

### Example 9: Ammonia Production in DBD Plasma Reactor Over Fe Nanotubes and Bimetallic Catalysts

In this exemplary embodiment, the Fe nanotubes and bimetallic catalysts have been tested for ammonia formation in DBD plasma reactor and the results are presented in Tables 18-20. The effect of the co-feeding of CO₂, and air and steam was studied.

Table 18 shows the results of ammonia production in presence of N₂ and O₂ in the ratio of 70:30 to create a composition similar to that of air and using steam as a source of H₂.

TABLE 18
Ammonia production in DBD plasma with Air and Steam

| | | | | | NH₃ | N₂ | Energy | |
|---|---|---|---|---|---|---|---|---|
| | N₂ | O₂ | Steam | Power | (mmoles/ | Conv. | Eff. | Energy |
| Catalyst | (lpm) | (lpm) | (l/min) | (W) | hr) | (%) | (g/kWh) | Eff. |
| Fe-Nanotubes | 0.032 | 0 | 0.0002 | 240 | 0.32 | 0.184% | 0.022 | 0.014% |
| (UV: 2 hrs) | | | | | | | | |
| Ga—Fe | 0.035 | 0.016 | 0.00005 | 195 | 0.05 | 0.025% | 0.004 | 0.003% |
| Nanotubes | | | | | | | | |
| Ni—Fe | 0.035 | 0.016 | | 180 | 0.08 | 0.040% | 0.007 | 0.004% |
| Nanotubes | | | | | | | | |
| Ni—Ga—TiO2 | 0.029 | 0.013 | 0.00005 | 180 | 0.11 | 0.067% | 0.010 | 0.006% |
| (Alloyed) | | | | | | | | |
| Lithium | 0.035 | 0.016 | 0.00005 | 240 | 0.02 | 0.008% | 0.001 | 0.001% |
| Tungstate | | | | | | | | |

TABLE 19
Ammonia production over Fe nanotubes and bimetallic
catalysts in DBD plasma with N₂/H₂-1

| | | | | NH₃ | N₂ | Energy | |
|---|---|---|---|---|---|---|---|
| | N₂ | H₂ | Power | (mmoles/ | Conv. | Eff. | Energy |
| Catalyst | (lpm) | (lpm) | (W) | hr) | (%) | (g/kWh) | Eff. |
| Fe-Nanotubes | 0.025 | 0.025 | 225 | 1.24 | 0.926% | 0.094 | 0.059% |
| (UV: 3 hrs) | | | | | | | |
| Fe-Nanotubes | 0.0585 | 0.0515 | 240 | 1.82 | 0.581% | 0.129 | 0.081% |
| (UV: 2 hrs) | | | | | | | |
| Ga—Fe | 0.025 | 0.025 | 150 | 0.84 | 0.624% | 0.095 | 0.059% |
| Nanotubes | | | | | | | |
| Ni—Ga—TiO2 | 0.025 | 0.025 | 180 | 1.06 | 0.791% | 0.100 | 0.063% |
| (Alloyed) | | | | | | | |

TABLE 20
Ammonia production over Fe nanotubes and bimetallic
catalysts in DBD plasma with CO₂, N₂/H₂-1

| | | | | | NH₃ | N₂ | Energy | |
|---|---|---|---|---|---|---|---|---|
| | N₂ | H₂ | CO₂ | Power | (mmoles/ | Conv. | Eff. | Energy |
| Catalyst | (lpm) | (lpm) | (lpm) | (W) | hr) | (%) | (g/kWh) | Eff. |
| Fe-Nanotubes | 0.056 | 0.052 | 0.009 | 240 | 5.13 | 1.73% | 0.364 | 0.228% |
| (UV: 2 hrs) | | | | | | | | |
| Ga—Fe | 0.050 | 0.050 | 0.010 | 180 | 0.37 | 0.14% | 0.035 | 0.022% |
| Nanotubes | | | | | | | | |
| Ga—Fe | 0.020 | 0.020 | 0.010 | 150 | 0.38 | 0.36% | 0.044 | 0.027% |
| Nanotubes | | | | | | | | |
| Ni—Ga—TiO2 | 0.020 | 0.020 | 0.010 | 195 | 0.35 | 0.33% | 0.031 | 0.019% |
| (Alloyed) | | | | | | | | |

The Fe nanotubes show an improved activity by 5-fold, 5 milli moles per hour of ammonia formation at SEI of 47 kWh/mol compared to Fe supported or alloyed catalysts which showed 0.5-2 mmol/h of ammonia formation.

### Example 10: In-Situ Absorption of Ammonia

To further improve the ammonia yield, ammonia absorbing agent MgCl₂ was used by mixing it with Fe-Nanotubes in the catalyst bed for both MW plasma and DBD plasma reactor. For both the reactors, the ammonia moles formed with and without MgCl₂ in the catalyst bed was recorded. The in-situ absorption of ammonia can shift the equilibrium-controlled reaction more towards product formation. To analyze/quantify how much ammonia is getting absorbed in MgCl₂, Thermogravimetric analysis (TGA) was carried out.

### Thermogravimetric Analysis for DBD Reactor

Two runs were performed on DBD reactor in presence of MgCl₂, in presence of same catalyst and at same throughput and power condition. For both the runs, N₂/H₂ ratio was kept as 1/1, with a total gas flow of 50 ml/min at 225 W power.

Run 1: The catalyst bed consists of Fe-nanotubes and MgCl₂ in weight ratio of 1:1. The reactor was run with just Nitrogen and Hydrogen. The run time for the experiment was 2 hours. MgCl₂ got completely saturated after this run.

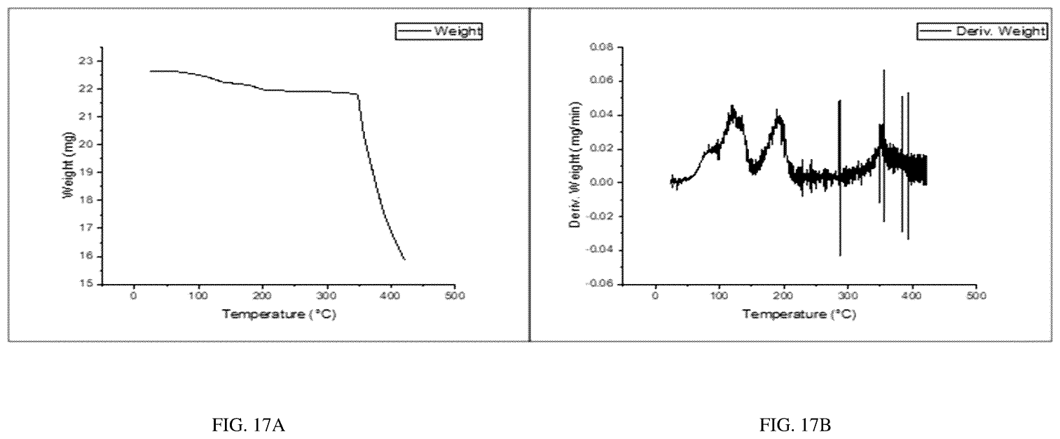

Run 2: The catalyst bed consists of Fe-nanotubes and MgCl₂ in weight ratio of 1:3. The reactor was run with just Nitrogen and Hydrogen. The run time for the experiment was 30 minutes. FIG. 17A-B shows the weight loss of MgCl₂ with respect to temperature.

TGA method for doing this analysis: The sample was heated from 27° C. to 350° C. at 5° C./min and from 350° C. to 420° C. at 10° C./hour. The initial weight of the samples was 22.6290 mg. The total weight loss for the sample is 6.816 mg which is 30.12% of the total weight. The weight loss after water loss (from 210° C. to 421° C.) is 6.128 mg which is 27.08% of the total weight.

### Thermogravimetric Analysis for MW Reactor

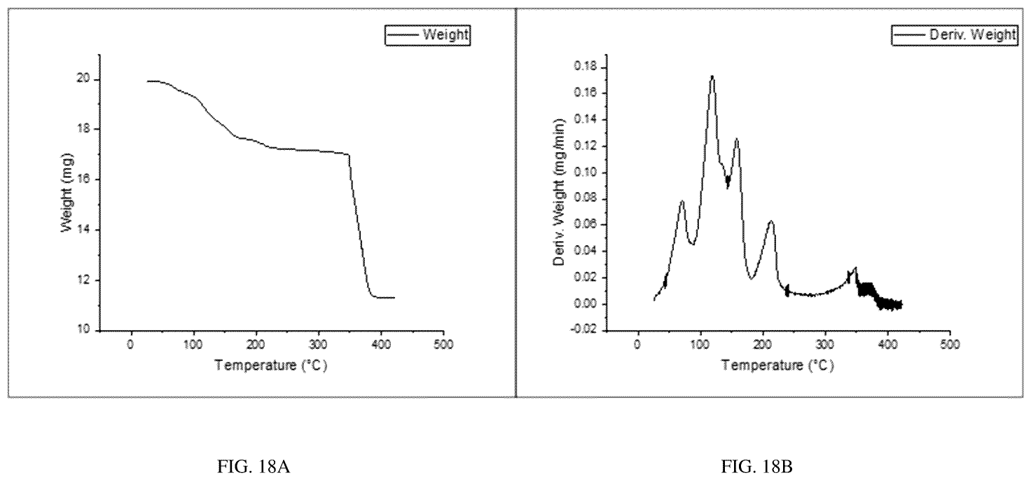

The catalyst bed comprises Fe-nanotubes and MgCl₂ in weight ratio of 1:1. Nitrogen (3 liters per minute) and CO₂ (0.3 liters per minute) was passed from sheath gas and hydrogen (1.1 liters per minute) from just below the catalyst bed. The run time for this experiment was 15 mins. From TGA curve, we can see that MgCl₂ got completely saturated in just 15 mins of run time. FIG. 18A-B shows the derivative weight loss of MgCl₂ with respect to temperature.

TGA method for analysis: The sample is heated from 27° C. to 350° C. at 5° C./min and from 350° C. to 425° C. at 5° C./hour. The total weight loss for the sample is 8.658 mg which is 43.4% of the total weight. The weight loss after water loss is 6.798 mg which is 34.08% of the total weight

### Example 11. Ammonia Production Using Plasma Torch and Fluidized Bed

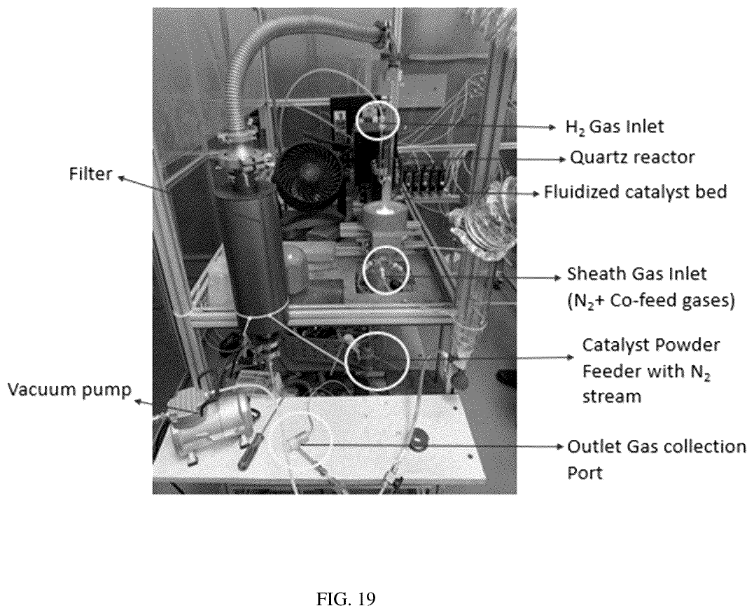

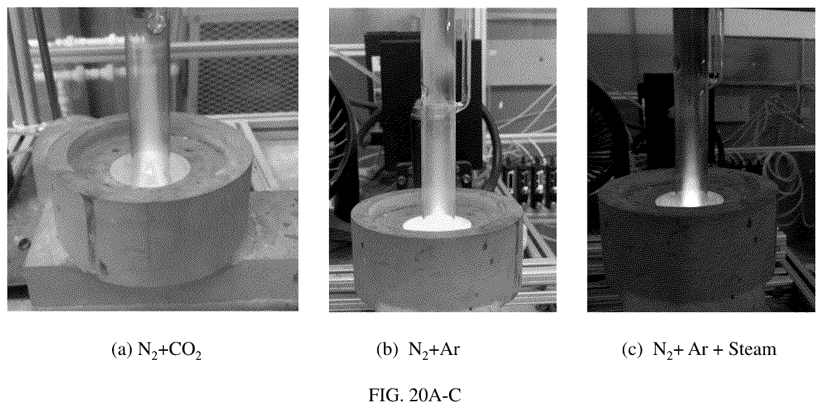

The tests described hereinabove are done on fixed bed catalyst operated in an adiabatic reactor at atmospheric pressure. The same tests were repeated in a fluidized bed reactor. The reactor setup used for ammonia production is shown in FIG. 19. The total N₂ gas flowing in the system was split into two streams: (i) N₂ enter as sheath gas and (ii) N₂ getting passed through the catalyst powder feeder to carry the catalyst particles into the reactor. Co-feed gases like CO₂/Ar/Steam were passed as sheath gas and H₂ from right above the plasma flame. The outlet of reactor was connected to a filter to collect all the catalyst powder coming out of the reactor. As the major gas flow is from bottom to top of the reactor, to have a proper fluidization, a vacuum pump was connected right after the filter to pull out all the gases. On the outlet of the vacuum pump, there is a port to collect gas samples and the rest goes to exhaust. FIG. 20A-C shows MW plasma flame under presence of different co-feed gases.

For the experiment with steam as the co-feed gas, Ar and N₂ were bubbled from a bottle filled with water at 80° C. This stream of Ar, N₂ and steam was passed through sheath gas and another stream of N₂ was passed from the catalyst powder feeder. Preliminary experiments indicated the formation of ammonia. In some experiments, NOₓ formation was evident with air leakage. The catalyst loading into reactor needs to be improved and the design of reactor needs to be properly done to ensure proper fluidization of the catalyst. A different reactor with larger length and width above the plasma flame for proper fluidization of catalyst powder may be used.

### Example 12: Establishing the Techno-Economic Process Feasibility and Life Cycle Analysis

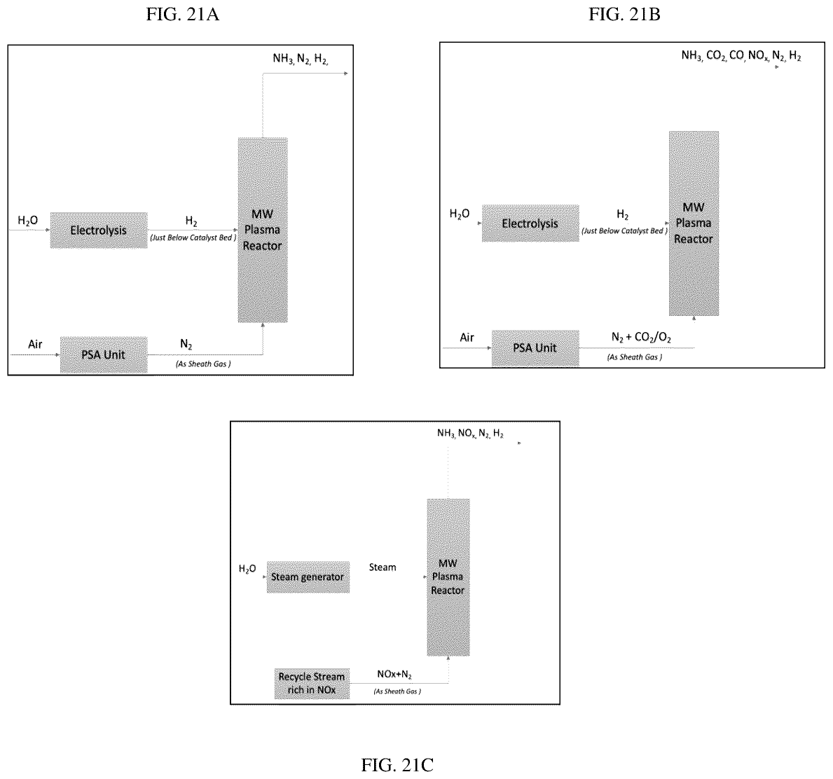

A simplified mass and energy balance analysis is done for ammonia production using three schemes that were investigated in Phase I. These schemes are illustrated in FIG. 21A-C. The net CO₂ emissions for each input for the process are obtained from literature and are summarized as shown in Table 21.

TABLE 21
List of net CO₂ emissions and costs associated with solar
electricity, nitrogen and ammonia separation.

| Item | Net CO₂ emissions | Cost | Comments |
|---|---|---|---|
| Electricity- | 8-50 gms/kWh | 5 cents per | Louwen et al., Nature |
| Solar | | kWh | Comm, |
| photovoltaics | | | DOI:10.1038/ |
| (lifetime) | | | ncomms13728 |
| | | | (2016); NREL-LCA |
| | | | Analysis |
| N₂-PSA | 0.4 kWh/Kg | 2 cents/Kg | Compressor energy |
| | | | requirement |
| Steam | 0.754 kWh/Kg | 3.77 | Steam at relatively low |
| | | cents/Kg | pressure (30-50 psig). |
| NH₃ | 0.4 kWh/Kg of | 2 cents/Kg | Assumption based on |
| Separation | all gases | of all gases | PSA for nitrogen; In |
| | | | some cases- |
| | | | it is treated as |
| | | | 3% additional |
| | | | cost or emissions. |

The cost and CO₂ emission analysis for scheme involving N₂ and H₂ chemistry may not change when you add small amount of CO₂ in the feedstock. So, the CO₂ emissions and cost analysis for both schemes shown in (a) and (b) are mostly influenced conversion, hydrogen, and electricity. The process was analyzed under the following conditions: 5 liters per minute for H₂, 10 liters per minute for N₂; 350 W power, 6% conversion based on N₂. The results are given below.

TABLE 22
Analysis of net CO₂ emissions for process chemistry involving N₂ and H₂

| | | | | | | Net Kg_{CO2} | Net Kg_{CO2} |
|---|---|---|---|---|---|---|---|
| | | | | | NH₃ | emissions/ | emissions/ |
| | | | | NH₃ | production | Kg—NH₃ | Kg—NH₃ |
| | H₂ | N₂ | Power | separation | rate | (Without | (with |
| Case | (g_{CO2}/hr) | (g_{CO2}/hr) | (g_{CO2}/hr) | (g_{CO2}/hr) | (gms/hr) | recycle) | recycle) |
| 8 | 32.14 | 2.37 | 2.8 | 2.53 | 27.3 | 1.46 | 0.4 |
| g/kwh | | | | | | | |
| 50 | 200.9 | 14.8 | 17.5 | 15.84 | 27.3 | 9.12 | 2.5 |
| g/kWh | | | | | | | |

TABLE 23
Analysis of net CO₂ emission for process
chemistry involving N₂ and steam.

| | | | | NH₃ | | Net Kgc_{CO2} |
|---|---|---|---|---|---|---|
| | | | | sepa- | NH₃ | emissions/ |
| | H₂O | N₂ | Power | ration | production | Kg—NH₃ |
| | (g_{CO2}/ | (g_{CO2}/ | (g_{CO2}/ | (g_{CO2}/ | rate | (Without |
| Case | hr) | hr) | hr) | hr) | (gms/hr) | recycle) |
| 8 g/ | 1.45 | 2.4 | 2.8 | 3% | 27.32 | 0.25 |
| kwh | | | | overall | | |
| 50 | 9.1 | 14.91 | 17.5 | 3% | 27.32 | 1.0 |
| g/kWh | | | | overall | | |

Cost Analysis-Schemes 1 and 2 are analyzed using 5 lpm of H₂, 10 lpm of N₂ and ammonia production at 6% conversion of N₂. The analysis suggests that the cost of production of NH₃ for scheme involving hydrogen and nitrogen comes to approximately $4940/ton-NH₃ without doing any recycle. Assuming recycling of gases after NH₃ condensation, the cost drops to about $1352 per ton-NH₃. The analysis clearly shows the importance of recycling on the overall cost of production for green ammonia using this process.

TABLE 24
Cost analysis for process scheme involving
N₂ and H₂ with hydrogen recycling.

| | | | NH₃ | NH₃ | Net | Net |
|---|---|---|---|---|---|---|
| | | | sepa- | production | cost/ | cost/ |
| H₂ | N₂ | Power | ration | rate | ton-NH₃ | ton-NH₃ |
| (cents/ | (cents/ | (cents/ | (cents/ | (gms/ | (without | (with |
| hour) | hr) | hr) | hr) | hr) | recycle) | recycle) |
| 0.74 | 0.04 | 1.75 | 3% | 27.32 | $4938 | $1352 |
| | | | overall | | | |

Analysis of the scheme involving steam and nitrogen yields cost for producing NH₃ at $1021 per ton-NH₃. In this scheme, we assumed 5 lpm of steam and 10 lpm of nitrogen to produce ammonia at 6% conversion of nitrogen.

TABLE 25
Cost analysis of process scheme involving steam and nitrogen

| Steam | N₂ | Power | NH₃ | NH₃ | Net cost/ton-NH₃ |
|---|---|---|---|---|---|
| (cents/ | (cents/ | (cents/ | separation | production | (without |
| hour) | hr) | hr) | (cents/hr) | rate (gms/hr) | recycle) |
| 0.91 | 0.05 | 1.75 | 3% overall | 27.32 | $1021 |

The cost of ammonia production using the plasma catalytic process primarily depends upon electricity cost for the process and also for producing hydrogen production using water electrolysis. If we integrate the plasma catalysis process with water electrolysis unit and use lower cost of renewable power then the cost of ammonia production can be much lower and may even compete well with large scale production.

### Example 13: Ammonia Reforming

Ammonia reforming experiments were performed in MW plasma reactor in presence of our Fe-Nanotubes. Tables 26-28 show the results of ammonia reformation in terms of % H₂ conversion. We observed that on increasing the catalyst bed temperature to above 400 C, resulted in about 87% of H₂ conversion. Results show that catalyst temperature effects conversions during ammonia formation under plasma catalysis process.

TABLE 26
Effect of catalyst with no temperature control

| Inlet Feed Condition | Catalyst | Power (W) | % H₂ conversion |
|---|---|---|---|
| Ar: 1 lpm, | No Catalyst | 400 | 80 |
| N₂: 3.27 lpm, | | | |
| NH₃: 0.54 lpm | Fe-Nanotubes | 400 | 74 |

TABLE 27
Effect of temperature on catalyst performance

| Inlet Feed | | Power | Temperature | % H₂ |
|---|---|---|---|---|
| Condition | Catalyst | (W) | (C) | conversion |
| Ar: 1 lpm, | Fe Nanotubes | 400 | ~150 | 74 |
| N₂: 3.27 lpm, | | | | |
| NH₃: 0.54 lpm | | 400 | 470 | 87 |

TABLE 28
Effect of higher ammonia flow with catalyst

| | NH3 | Power | Temperature | % H₂ |
|---|---|---|---|---|
| Inlet Feed Condition | (lpm) | (W) | (C) | conversion |
| Ar: 1 lpm, | 0.54 | 400 | 470 | 87 |
| N₂: 3.27 lpm | 1.3 | 400 | 470 | 86 |

### Example 14: Another Set Up for Ammonia Manufacture Using Plasma Catalysis

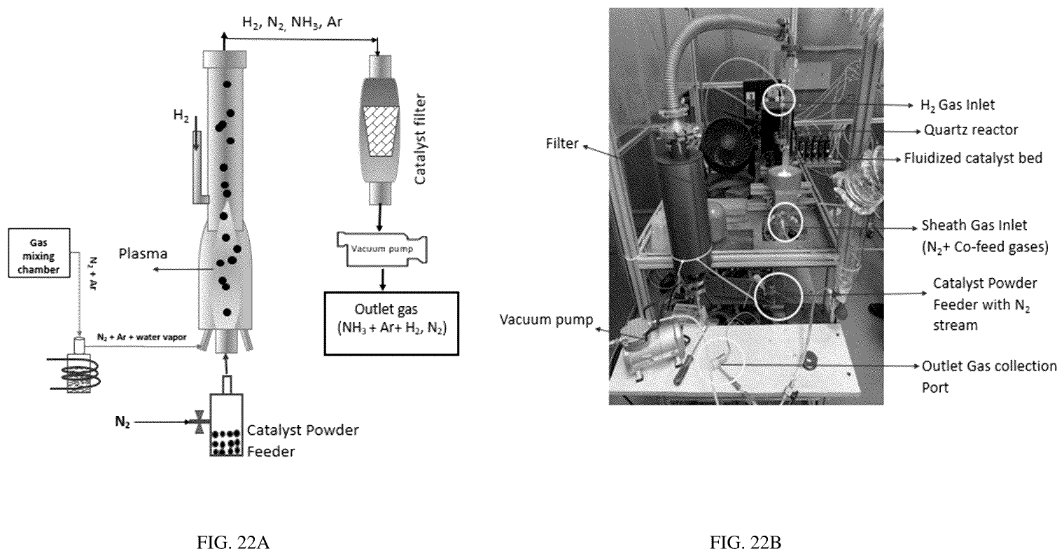

Process gases need to flow through sheath for conversion due to higher residence time and effective microwave power absorption at least in the reactor configuration considered here. Fluidization experiments were conducted to understand plasma-catalytic effect on NOₓ formation and ammonia production in accordance with FIG. 22A-B. FIG. 22A-B shows a schematic and the photo of actual setup used for experiments. Experiments indicate ammonia formation. A new design for a small lab reactor for fluidization experiments will improve contact time between catalyst and plasma excited gas phase species. In the current design, the catalyst particles have been entrained mostly due to shaping of the reactor. Experiments with nitrogen and water vapor alone also resulted in NOₓ species formation.

### Example 15: Dielectric Barrier Discharge (DBD) Plasma Catalytic Production of Ammonia

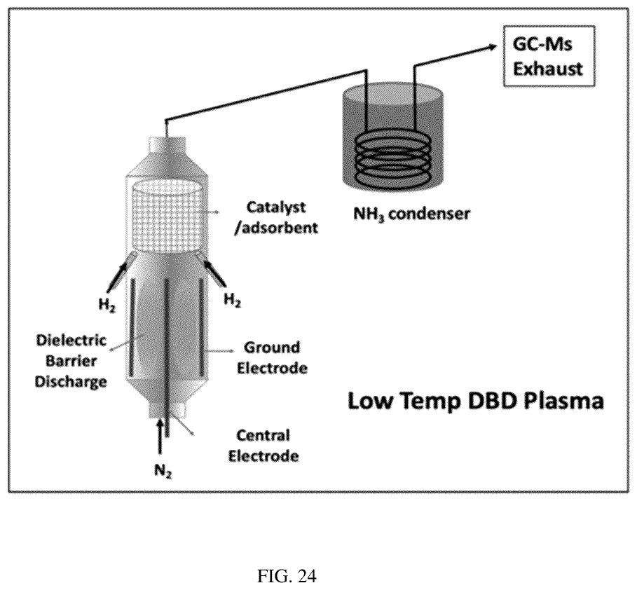

Experiments were also performed using a dielectric barrier discharge (DBD) reactor using a one inch quartz tube packed with alumina ceramic spherical granules mixed with catalyst powder. See FIG. 24 for schematic and photo of the exact setup. The DBD reactor is powered by a low frequency AC power source (300 W total power) between central electrode and ground electrode wrapped around the quartz tube. The tube is thermally insulated to increase the temperature of the catalyst bed. The following are highlights using DBD reactor from Phase I effort.

Experiments using 25 ml/min of nitrogen, 25 ml/min of hydrogen and using iron nanotubes, the production of ammonia is obtained at a rate up to 1.5 mmol per hour. The amount of catalyst used was about one gram. By adding ammonia absorbent (Magnesium Chloride), the experiment yielded about an order of magnitude improvement in ammonia production, i.e., about 30-50 mmol per hour. The power was kept at about 240 W.

Reduced iron nanotubes outperformed other catalysts. Many catalysts including iron alloyed into titania nanowires and tungsten oxide nanowires all performed almost at similar levels. The yield and production rates of ammonia could be improved by optimizing diameter, catalyst temperature and throughput.

TABLE 29
State of the art results with DBD plasma catalytic reactor.

| | Energy | Prod. rate, | |
|---|---|---|---|
| | Efficiency, | mmol/ | |
| Catalyst | g/kWh | min · g_{cat} | References |
| Ga, Fe, Ni, | 0.2-1.8 | <.1 | Shah et al., 2018,¹⁰ |
| Ru | | | Akay et al., |
| | | | 2016,¹⁶ Li et al;¹⁷ |
| | | | Peng et al.,¹⁸ |
| | | | Ramirez et al., 2015,¹⁹ |
| | | | Tu et al;²⁰ Patil |
| | | | et al., 2021;²¹ Xie 2020²² |
| Co—Ni | 0.8 | 3 | Liu et al., 2021²³ |
| Ru | 35 | .8 | Kim et al., 2017²⁴ |
| Ru + Mol. | 1.7 | | Peng et al, 2017²⁵ |
| Sieve | | | |
| 13X | | | |

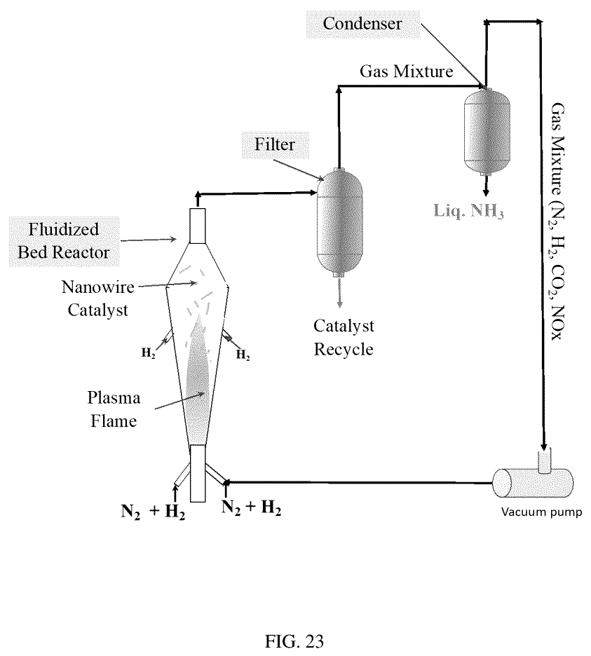

Using the setup shown in FIG. 23, we will optimize catalyst loading in the gas phase, throughput (5-100 lpm/kW), gas composition (N₂ to H₂ to steam). Phase I studies showed that it is possible to use steam along with nitrogen within sheath gas through plasma flame. With additional introduction of hydrogen from above the flame, the ammonia production rate exceeded 300 mmol per hour at 300 W power. It would be important to optimize the gas composition on production rate and conversion in single pass configuration and then for recycled stream configuration.

The contact time between catalyst and the excited gas phase will be varied by extending the tube height for fluidization and catalyst particle loading density. The outlet gas stream is analyzed by GC/GC-MS for ammonia concentration. Inlet and outlet flow rates will be measured and used for correlating with the computed conversion. The OES will be used to analyze the gas temperature and populations of nitrogen species (N₂+, N₂ (v), NO, NO₂, N⁺, NH⁺). Using infra-red pyrometer, we will use statistical measurements of temperature to understand the temperature of catalyst particles as function of loading and location within fluidizing region. The region above the flame will be thermally insulated for low power operation and air cooled for higher power operations.

The feed rates of catalyst, recycling, and gas will be adjusted to fluidize the bed. High gas flow rate and plasma power give a high volume of plasma. The fluidization is highly dependent on total flow rate, catalyst particle size, and density. The additional carrier gas may be used to maintain a minimum fluidization velocity and also to control the process temperature as in the following equation.

$${u}_{mf} = \frac{( {d}_{p} )}{150 μ} [ g ( {ρ}_{p} - ρ ) ] \frac{{ε}_{mf}^{3}}{{( 1 - {ε}_{mf} )}^{2}}$$

where uₜ is terminal settling velocity, m/s; u_{mf} is minimum fluidization velocity, m/s; dₚ is particle diameter, m; ρₚ is particle density, kg/m³; ρ is the fluid density, kg/m³; C_{D} is drag coefficient; μ is the viscosity of the fluid, cₚ; ε_{mf} is a void fraction.

### Example 16: Optimization of a DBD Reactor Using Catalyst-Adsorption

Dielectric barrier discharge (DBD) plasma as a type of Low temperature plasma (LTP), generates highly energetic electrons and reactive species (e.g., radicals, excited atoms, molecules, and ions) that can significantly enhance reaction kinetics and enable thermodynamically unfavorable reactions to proceed under ambient conditions (e.g., dissociation of N₂).¹⁴ Both the electrons and reactive species play a vital role in the initiation and propagation of a variety of physical and chemical reactions in low-temperature plasma processes. In this task, a modified DBD plasma catalysis packed bed reactor will be used. The reactor comprises a quartz tube with DBD plasma zone and packed catalyst/adsorbent zone. The DBD is generated in the reactor using a high voltage AC power source (PMV500) with a frequency in the range of 20-25 kHz. The voltage and charge will be measured using an oscilloscope. For the NH₃ synthesis, the N₂ gas enters the DBD plasma zone and gets activated. The H₂ gas is introduced into the reactor at the entrance of the catalyst zone. Dielectric Barrier Discharge (DBD) reactors are interesting for gas processing applications because of their simplicity and the use of packed bed for creating discharge. DBDs are a typical example of nonequilibrium electrical gas discharge that can be operated at pressures of the order of 1-10 bar. The catalyst pellets can be made using dielectric media (such as ceramic or quartz balls) mixed with active metal catalysts.

In an exemplary embodiment, the use of ammonia absorbent along with iron nanotubes mixed with alumina spherical balls resulted in an order of magnitude higher ammonia production rate (˜>50 mmol g⁻¹ h⁻¹).

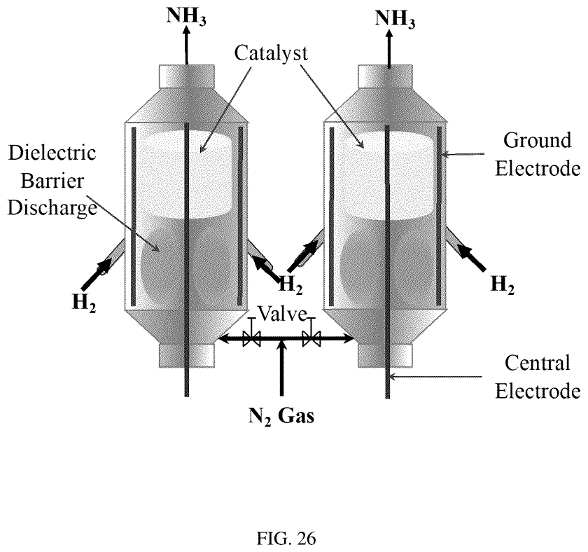

One embodiment provides a two-bed solution for DBD reactor for producing ammonia using generation and regeneration steps as shown in FIG. 26. The packing may be made using alumina spherical balls mixed with catalyst and ammonia absorbent. One bed may be subjected to plasma excitation with feed gases for generation until the absorbent is near saturated. During this time, the second bed may be subjected to regeneration using DBD plasma in the absence of feed gases. The generation and regeneration steps may need to be optimized through the use of interrupted plasma with on and off time scales for proper heat control. The design of the reactor also needs to be optimized for dimensions (diameter and length for a certain power), packing materials dimensions (sphere sizes) and throughput of gases and pressure.

Also, there is strong evidence to suggest that altering the physical properties of the catalyst material (e.g., dielectric constant, surface area, particle size, and void fraction) can modify the electric field, which subsequently alters the density and mode of the plasma discharge. Application of a plasma to a catalyst can change the chemical or electronic properties of the catalyst (e.g., in the metal oxidation state or work function), reduce catalyst poisoning, modify surface reaction pathways, or change the catalyst morphology by increasing the surface area or improving catalyst dispersion, all of which can enhance the catalyst performance. In one embodiment, catalyst durability over several cycles and lifetime when used with and/or without the ammonia absorbent may also be observed.

### Example 17: Large Scale Production of Fe Nanotube and its Alloy Catalysts

In one embodiment, as shown in FIG. 14 is provided iron nanotubes using ZnO nanowires as sacrificial templates using UV excitation of ZnO nanowire powder dispersed in iron nitrate solution. Under UV excitation, the conduction band electrons reduce the iron forming iron deposition uniformly on ZnO nanowire. Subsequently, the iron deposited ZnO nanowires are washed using 2M sulfuric acid resulting in dissolution of ZnO leaving iron nanotubes. In one embodiment, is provided ZnO nanowire powders at large quantities. So, scale-up of production of iron nanotubes requires only scaleup of UV excitation, ZnO dissolution steps. The resulting iron nanotube powders can be reduced using a packed bed reactor and hydrogen. Once reduced, the iron nanotube powders can be stored in inert bags and can be used later.

### Example 18: Design, Assembly and Testing of 6 kW Microwave Plasma Torch Fluidized Bed Reactor

Fluidized-bed reactors offer a much higher efficiency in heat exchange, compared to fixed beds, and better temperature control, due to the turbulent gas flow and rapid circulation. A 3 KW plasma source will be used in a fluidized bed reactor for ammonia production at atmospheric pressure.

In one embodiment is provided a process setup for a fluidized bed using 3 kW plasma power, N₂/H₂ ratio, catalyst residence time, gas flow rates (20-100 lpm/kWh), catalyst feed and recirculation rate, and catalyst particle size for maximum ammonia production capacity. The feed rates of catalyst, recycling and gas may be adjusted to fluidize the bed. High gas flow rate and plasma power give high volume of plasma. In-situ absorption media can be mixed with catalyst particles.

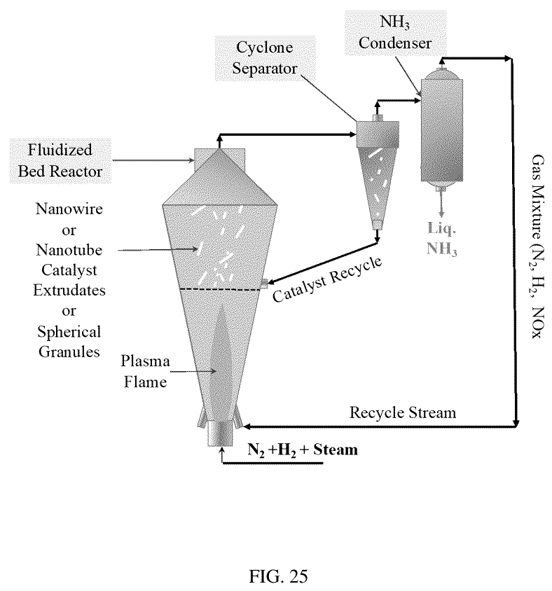

Finally, we will incorporate 6 kW plasma torch (either from MKS Instruments or iPLas) and run the reactor using throughput of 500 lpm of processing gas (nitrogen and steam) while recycle stream to be sent through side ports. The catalyst will be introduced from above the flame. The fluidization is highly dependent on total flow rate, catalyst particle size and density. Additional carrier gas may be used to maintain a minimum fluidization velocity and also to control the process temperature. See FIG. 25 for an example setup. ADEM developed such a reactor for producing nanowire based materials by fluidizing 50 micron size metal powders with air plasmas. Here, the same reactor will be modified for ammonia production studies with fluidizing either nanowire/nanotube catalysts either in the form of 0.2-0.6 mm size granules/extrudates or individual particles.

### Example 19: Design Scaleup of Modular Unit Using Plasma Power Sources Up to 100 kW

We have identified three primary challenges for plasma-catalytic process: scale up of plasma sources, plasma-catalyst interactions and improving energy efficiency. The high input microwave power required to sustain the plasma at rather high throughput can be achieved by: (1) coupling multiple microwave generators to a single reactor or 2) developing single unit microwave sources with >100 kW output power at lower frequencies (e.g. 433 MHz). It is also possible to design atmospheric radio-frequency plasma discharges for large pipes to accommodate high flow rates of gases for scale-up. The use of 915 MHz sources can allow for larger diameter for applicator compared to 2.45 GHz. In one embodiment, we can integrate a 6 kW 915 MHz plasma torch in a fluidized bed reactor. It is also possible to consider other lower frequency plasma discharges (RF and lower than 1 MHZ) for atmospheric torches. The efficiency of plasma power absorption can be higher with higher frequencies. Also, the commercial availability of plasma power sources at microwave frequency range are much higher. Plasma power sources are available up to 100 kW power.

It is intended that the disclosure and examples be considered as exemplary only.

While the invention has been described in terms of its preferred embodiments, those skilled in the art will recognize that the invention can be practiced with modification within the spirit and scope of the appended claims. Accordingly, the present invention should not be limited to the embodiments as described above, but should further include all modifications and equivalents thereof within the spirit and scope of the description provided herein.

1. A method for producing ammonia, comprising:
oxidizing N₂ gas in a plasma discharge reactor to form NOₓ where x is 1 or 2; and
hydrogenating NOₓ in the presence of H₂ on a catalyst to form ammonia.

2. The method of claim 1, wherein the oxidizing step is performed by contacting N₂ with steam.

3. The method of claim 1, wherein the oxidizing step is performed by contacting N₂ with CO₂.

4. The method of claim 1, wherein the oxidizing step is performed by contacting N₂ with air or oxygen.

5. The method of claim 1, wherein the oxidizing step is performed in the presence of argon gas.

6. The method of claim 1, wherein the hydrogenating step is performed by introducing H₂ at a position above a plasma flame in the plasma discharge reactor.

7. The method of claim 1, wherein the plasma discharge reactor is selected from the group consisting of a microwave (MW) plasma torch reactor, a dielectric barrier discharge (DBD) reactor, a radio-frequency (RF) plasma discharge reactor, hot filament reactor, and arc discharge reactor.

8. The method of claim 1, wherein the catalyst is a transition metal catalyst.

9. The method of claim 1, wherein the catalyst is a nanowire or nanotube catalyst.

10. The method of claim 1, wherein the catalyst is selected from the group consisting of iron alloyed into titania nanowires; iron nanowires; iron-ruthenium alloyed nanoparticles, nanowires, or nanotubes; iron or nickel nanoparticles; iron, nickel, or cobalt nanoparticles with or without alloyed platinum; iron nanotubes; iron nanotubes alloyed with ruthenium or platinum; and lithium aluminate nanowires.

11. The method of claim 1, wherein the reactor comprises a fixed catalyst bed and wherein the catalyst is in an extrudate form or is coated on monoliths.

12. The method of claim 1, wherein the reactor comprises a fluidized catalyst bed and wherein the catalyst is in the form of a powder from 10 micron to 10 mm scale.

13. The method of claim 1, wherein the method is performed at a pressure of less than 5 bars.

14. The method of claim 1, wherein a gas flow rate through the reactor is from 5-100 lpm/kWh.

15. The method of claim 1, wherein the reactor comprises an ammonia adsorbent either mixed with or positioned downstream of the catalyst.

16. The method of claim 1, wherein the method is adiabatic and no external heat is supplied to the catalyst.

17. A method for producing ammonia, comprising:
providing a plasma discharge reactor with a fixed or fluidized catalyst bed;
introducing N₂ gas and an oxidizing agent into a plasma flame of the plasma discharge reactor;
introducing hydrogen at a position above the plasma flame over catalyst to produce ammonia; and
collecting the ammonia produced.
